(19) United States
(12) Patent Application Publication
(10) Pub. No.: US 2026/0094731 A1
(43) Pub. Date: Apr. 2, 2026

(54) ANNULAR LINEAR INDUCTION PUMP

(71) Applicants: Mohamed S. El-Genk, Albuquerque, NM (US); Ragai Altamimi, Albuquerque, NM (US)

(72) Inventors: Mohamed S. El-Genk, Albuquerque, NM (US); Ragai Altamimi, Albuquerque, NM (US)

(21) Appl. No.: 19/346,381

(22) Filed: Sep. 30, 2025

Related U.S. Application Data
(60) Provisional application No. 63/701,509, filed on Sep. 30, 2024.

(51) Int. Cl. G21C 15/247; H02K 44/06

(52) U.S. Cl. CPC G21C 15/247; H02K 44/06

(57) ABSTRACT

An annular linear induction pump comprises a casing, an annular duct disposed within the casing, the annular duct having an inner surface and an outer surface, and an electromagnet. The electromagnet can include a center component located within the annular duct and forming the inner surface of the annular duct, a plurality of stators disposed radially around the annular duct, and, a plurality of coils. The annular linear induction pump can be submersible within piping of a nuclear reactor power system.

### PRIORITY CLAIM AND CROSS-REFERENCE TO RELATED APPLICATIONS

This application claims priority to U.S. provisional patent application No. 63/701,509 filed Sep. 30, 2024, and entitled “Miniature, Submersible Annular Linear Induction Pump for Industrial, Solar Energy, Mining Applications and Test Loops Supporting Development of Advanced Nuclear Reactors,” which is incorporated by reference herein in its entirety.

### STATEMENT REGARDING FEDERALLY SPONSORED RESEARCH & DEVELOPMENT

This invention was made with government support by the U.S. Department of Energy grant DE-AC07-05ID14517. The government has certain rights in the invention.

### BACKGROUND

The Annular Linear Induction Pumps (ALIPs) with no moving parts have been used for circulating liquid metals in test loops, various industrial applications, and space nuclear reactor power systems. The absence of moving parts prolongs the operation lives of the ALIPs and the sealed structure eliminates fluid leakage and decreases maintenance. Polzin et al. have designed and experimentally investigated the performance of an ALIP for circulating liquid NaK-78 at 125° C. to 525° C. in a test loop to support the development of the affordable fission surface power system for potential deployment on the lunar surface. The coils, in this ˜22 cm diameter pump, were cooled by forced convection of helium gas. The highest measured pump efficiency for circulating liquid NaK-78 at 125° C., 120 VAC, 33 Hz was ˜6%, the measured pumping pressure at zero flow was 90 kPa and the highest flow rate was 20.5 m³/h.

Kim and Lee have designed and experimentally evaluated an ALIP for circulating liquid sodium at 150° C. in an experimental test loop to support the development of a prototype liquid metal reactor. This 30-cm diameter pump with asbestos bands for electrically insulating the ribbon-shaped coils' winding. When operated at terminal voltage of 227 VAC and current frequency of 60 Hz the ALIP produced a pumping pressure of 125 kPa at a flow rate of 3.6 m³/h. Nashine and Rao have designed and experimentally evaluated an ALIP for circulating liquid sodium at 350° C. to support the development of an Indian prototype Fast Breeder Reactor (FBR). This 59.0 cm diameter pump used external air-forced convection to maintain the temperature of the coils at 100-120° C. and avoid melting the electrical insulation and short-circuiting the coils. At a terminal voltage of 360 VAC and current frequency of 50 Hz, the measured net pumping pressure at a flow rate of 125 m³/h was 394 kPa and the corresponding pump efficiency was 18%.

Kwak and Kim have designed and fabricated a medium size ALIP for circulating liquid sodium at 340° C. in an out-of-pile thermal-hydraulics test loop for supporting the development of a Korean FBR. The coils of this 46 cm diameter pump were cooled by forced convection of air. When operated at a terminal voltage of 391 VAC and a current frequency of 60 Hz, the measured net pumping pressure was four hundred kPa at a sodium flow rate of eighty-five m³/h and a pump efficiency of 25%.

While ALIP external cooling is readily used in out-of-pile test loops and industrial applications, using submersible ALIPs is preferable and more practical for in-pile test loops. It simplifies the design and operation of the loops and avoids having penetrations into the test reactor core for circulating an external coolant for the pump, such as helium. Ota et al. have designed and measured the performance of a submersible ALIP for circulating liquid sodium at 452° C. in the core of the Japanese pool-type FBR. This ALIP used electrically insulating but thermally conductive insulation comprised of layers of alumina and glass cloth and mica tape to transfer the dissipated thermal power by the pump to the circulating liquid sodium in the surrounding sodium pool. The 190 cm diameter and 440 cm long ALIP had a 7.7 cm wide liquid flow annulus for circulating liquid sodium at high flow rates. The ALIP performance has been evaluated for 2,550 hours in an experimental test facility. At a terminal voltage of 1,350 VAC and a current frequency of 20 Hz, the measured net pumping pressure was 250 kPa, at sodium flow rate of 9,600 m³/h and ALIP efficiency of 40%.

Nashine et al. have developed a submersible ALIP design for draining liquid sodium from the main vessel of the Indian FBR at temperatures up to 550° C. This submersible pump used copper winding wires with high-temperature inorganic mineral electrical insulation of magnesium oxide, MgO. The generated thermal power by joule heating in the wires during the operation of this 40 cm diameter ALIP was removed by the surrounding sodium flow. When this ALIP operated at terminal voltage of 150 VAC and current frequency of 50 Hz in sodium pool, the measured net pumping pressure at sodium flow rate of 2.0 m³/h was four hundred kPa. These large-diameter submersible ALIPs are not suitable for uses in small-diameter out-of-pile and in-pile test loops. For these loops, miniature submersible ALIPs are preferable. Recently, preliminary designs of two in-pile test cartridge loops have been developed in the US for supporting the development of molten lead and liquid sodium-cooled Generation-IV reactors. These test loops were to be placed into the core of the Versatile Test Reactor (VTR) to investigate the compatibility of various nuclear fuel and structural materials and the prevailing corrosion mechanisms of these heavy and alkali liquid metals under prototypical temperature and radiation environment. The pool-type, sodium-cooled, three hundred MWₜₕ Versatile Test Reactor (VTR) is one-of-a-kind for performing large-scale, fast-neutron irradiation tests at elevated temperatures. Planned compatibility and corrosion tests with circulating molten lead were to initially be conducted with 316-stainless steel nuclear fuel cladding and structure material at temperatures up to 500° C. and then at higher temperatures with nickel-free steels such as FeCrAl or similar materials.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A includes a diagram of a test cartridge loop 100 of a nuclear reactor power system, in accordance with one or more example implementations described herein.

FIG. 1B is a cross-sectional view of the test cartridge loop 100, in accordance with one or more example implementations described herein.

FIG. 2A shows a radial cross-sectional view of an annular linear induction pump 200, in accordance with one or more example implementations described herein.

FIG. 2B shows an axial cross-sectional view of an annular linear induction pump 200, in accordance with one or more example implementations described herein.

FIG. 3 is a diagram showing an axial cross-sectional view of a linear annular induction pump that illustrates operation of the linear annular induction pump, in accordance with one or more example implementations described herein.

FIG. 4 shows the phase relationship of the coil connection with 3-phase power, in accordance with one or more example implementations described herein.

FIG. 5A shows that for pole 1 the magnetic field Br travels radially towards the stator and the eddy current Iᵢ travels circumferentially in a counter-clockwise direction, in accordance with one or more example implementations described herein.

FIG. 5B shows that for pole 2 the magnetic field Br travels radially toward the center core and Iᵢ travels circumferentially in a clockwise direction.

FIG. 6 is a diagram of a section of an in-pile test loop that includes a riser tube and an annular linear induction pump, in accordance with one or more example implementations described herein.

FIG. 7 is a 3-phase wiring configuration of a pole pair present in an annular linear conduction pump, in accordance with one or more example implementations described herein.

FIG. 8 is an electrical equivalent circuit diagram of an annular linear conduction pump, in accordance with one or more example implementations described herein.

FIG. 9 is a diagram illustrating the leakage magnetic flux in a stator slot 900, in accordance with one or more example implementations described herein.

FIGS. 10A and 10B shows a comparison of the predictions of an improved equivalent circuit model (ECM) according to implementations described herein and a previously proposed ECM to experimental results for a low-flow sodium annular linear induction pump.

FIG. 11 shows overpredictions of annular linear induction pumps using an improved ECM according to implementations described herein and a previously proposed ECM compared to reported experimental results for a low sodium flow annular linear induction pump.

FIG. 12A-12C indicates calculated performance of an annular linear induction pump according to one or more example implementations described herein for circulating molten lead at 500° C. for different terminal voltages.

FIG. 13A-13C indicates calculated performance of an annular linear induction pump according to one or more example implementations described herein for circulating molten lead at 500° C. for different supplied current frequencies.

FIG. 14A-14C indicates calculated performance of an annular linear induction pump according to one or more example implementations described herein for circulating molten lead at 500° C. using ceramic insulated coil wires at different diameters.

FIG. 15A-15C indicates calculated performance of an annular linear induction pump according to one or more example implementations described herein for circulating molten lead at 500° C. using different lengths of the center core.

FIG. 16A-16C indicates calculated performance of for circulating molten lead at 500° C. for different widths of the annular flow an annular linear induction pump duct according to one or more example implementations described herein.

FIG. 17 shows a comparison of the calculated supply curve by an annular linear induction pump according to one or more example implementations described herein and the demand curve for a VTR molten lead test loop as a function of the flow rate.

FIGS. 18A and 18B indicates the effect of molten lead temperature on performance of annular linear induction pumps according to one or more example implementations described herein.

FIGS. 19A and 19B indicates the effect of liquid sodium temperature on the performance of annular linear induction pumps according to one or more example implementations described herein.

FIGS. 20A and 20B indicates the effect of liquid NaK-78 temperature on the performance of annular linear induction pumps according to one or more example implementations described herein.

### SUMMARY

In one or more examples, an annular linear induction pump includes a casing; an annular duct disposed within the casing, the annular duct having an inner surface and an outer surface, and an electromagnet. The electromagnet can include a center component located within the annular duct and forming the inner surface of the annular duct, a plurality of stators disposed radially around the annular duct, and a plurality of coils. In various examples, the linear annual induction pump can have an outer diameter from about 40 millimeters (mm) to about 100 mm and a length from about 800 mm to about 1500 mm.

It is to be understood that both the foregoing general description and the following detailed description are exemplary and explanatory only and are not restrictive of the invention, as claimed.

### DETAILED DESCRIPTION

Detailed embodiments of the present invention are disclosed herein; however, it is to be understood that the disclosed embodiments are merely example implementations of the inventive concepts, which may be embodied in various forms. Therefore, specific structural and functional details disclosed herein are not to be interpreted as limiting, but merely as a representative basis for teaching one skilled in the art to variously employ the inventive concepts in virtually any appropriately detailed method, structure, or system. Further, the terms and phrases used herein are not intended to be limiting, but rather to provide an understandable description of the inventive concepts.

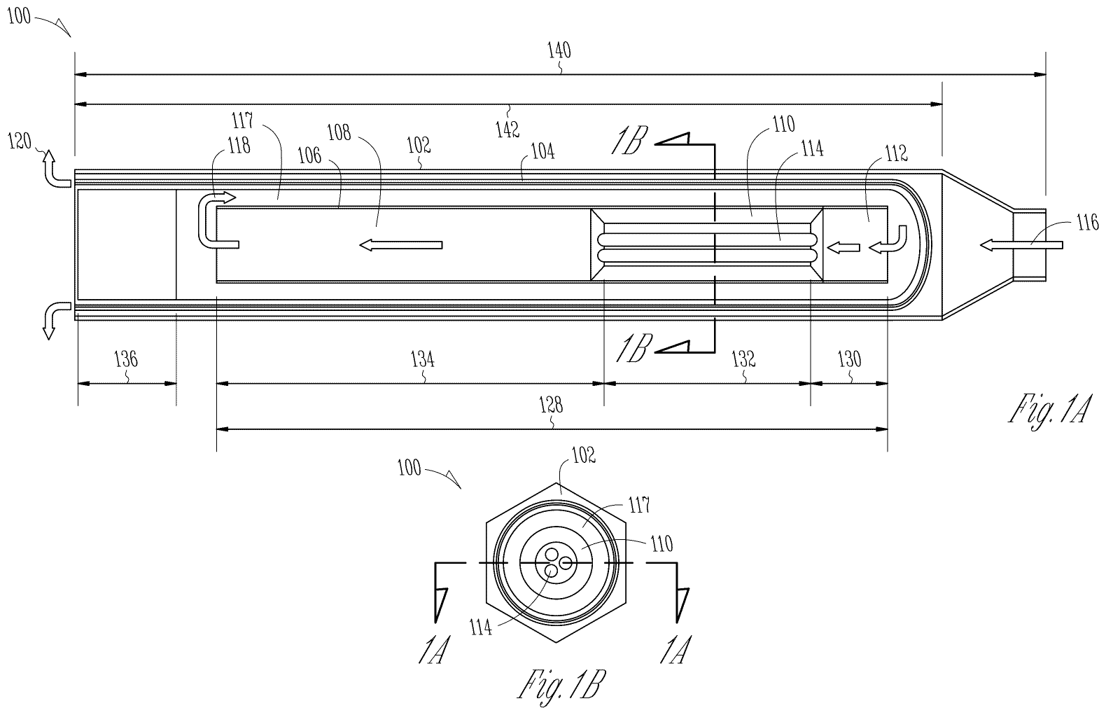

FIG. 1A includes a diagram of a test cartridge loop 100 of a nuclear reactor power system, in accordance with one or more example implementations. In one or more examples, the nuclear reactor power system can include a versatile test reaction (VTR) nuclear reactor power system. In one or more additional examples, the nuclear reactor power system can include a very-small, long-life modular nuclear reactor power system. In one or more further examples, the nuclear reactor power system can include a small, long-life modular nuclear power reactor system. In still other examples, the nuclear reactor power system can include a generation IV nuclear power reactor system. The power capacity of the nuclear power reactor system can be from 10 megawatts thermal (MWth) to about 500 MWth per unit. In various examples, the nuclear power reactor system can have a power capacity from about 10 MWth to about 100 MWth, from about 100 MWth to about 300 MWth, or from about 300 MWth to about 500 MWth.

The test cartridge loop 100 can include a shroud 102 having a test cartridge 106 having an outer flow area 104 and an internal flow area 108. In one or more examples, the test cartridge loop 100 can be included in a nuclear reactor power system that uses one or more liquids for cooling operations. The one or more liquids can flow through at least one of the outer flow area 104 and the internal flow area 108 and can include molten lead, liquid sodium, or liquid sodium potassium. In one or more illustrative examples, the one or more liquids flowing through the test cartridge loop 100 can include NaK-78. In various examples, temperatures of the one or more liquids flowing through the test cartridge loop 100 can be from about 300° C. to about 1200° C., from about 300° C. to about 700° C., from about 500° C. to about 1000° C., from about 700° C. to about 1200° C., from about 300° C. to about 500° C., from about 400° C. to about 600° C., from about 500° C. to about 700° C., from about 600° C. to about 800° C., from about 700° C. to about 900° C., from about 800° C. to about 1000° C., from about 900° C. to about 1100° C., or from about 1000° C. to about 1200° C.

The test cartridge 106 can include an internal chamber 110 that includes one or more testing rods 114. The flow of one or more liquids through the internal chamber 110 and the internal flow area 108 can be shown by 112 and 118 with the flow of one or more liquids through the shroud 102 can originate at an inlet 116. In various examples, the test cartridge 106 can include an outer shell 117. An outlet 120 can transport heated liquids out of the shroud 102.

In at least some examples, the test cartridge 106 can include an annular downcomer 128 having a lower section 130, a test section 132, and a riser 134. The shroud 102 can also include a gas plenum 136. The shroud 102 can have a first height 140 that corresponds to the length through which one or more first cooling liquids flows, such as a liquid sodium coolant. In one or more examples, a second height 142 can correspond to a lead/sodium liquid coolant loop.

In one or more examples, the test cartridge 106 can have an inner diameter from about 50 mm to about 250 mm, from about 75 mm to about 200 mm, from about 50 mm to about 150 mm, from about 100 mm to about 200 mm, from about 150 mm to about 250 mm, from about 50 mm to about 100 mm, from about 50 mm to about 70 mm, from about 60 mm to about 80 mm, from about 70 mm to about 90 mm, or from about 80 mm to about 100 mm.

In one or more additional examples, an annular linear induction pump disposed in the test cartridge 106 can be placed in a pipe or other conduit such that a gap is present between the outer surfaces of the annular linear induction pump and the inner surfaces of the pipe or conduit. In one or more illustrative examples, the gap can be from 0.1 mm to about 10 mm, from about 0.5 mm to about 5 mm, from about 1 mm to about 3 mm, from about 0.5 mm to about 2 mm, from about 2 mm to about 4 mm, from about 4 mm to about 6 mm, from about 6 mm to about 8 mm, or from about 8 mm to about 10 mm.

FIG. 1B is a cross-sectional view of the test cartridge loop 100, in accordance with one or more example implementations. FIG. 1B shows the shroud 102 with the outer shell 117 of the test cartridge 106 and the internal chamber 110 comprising the testing rods 114.

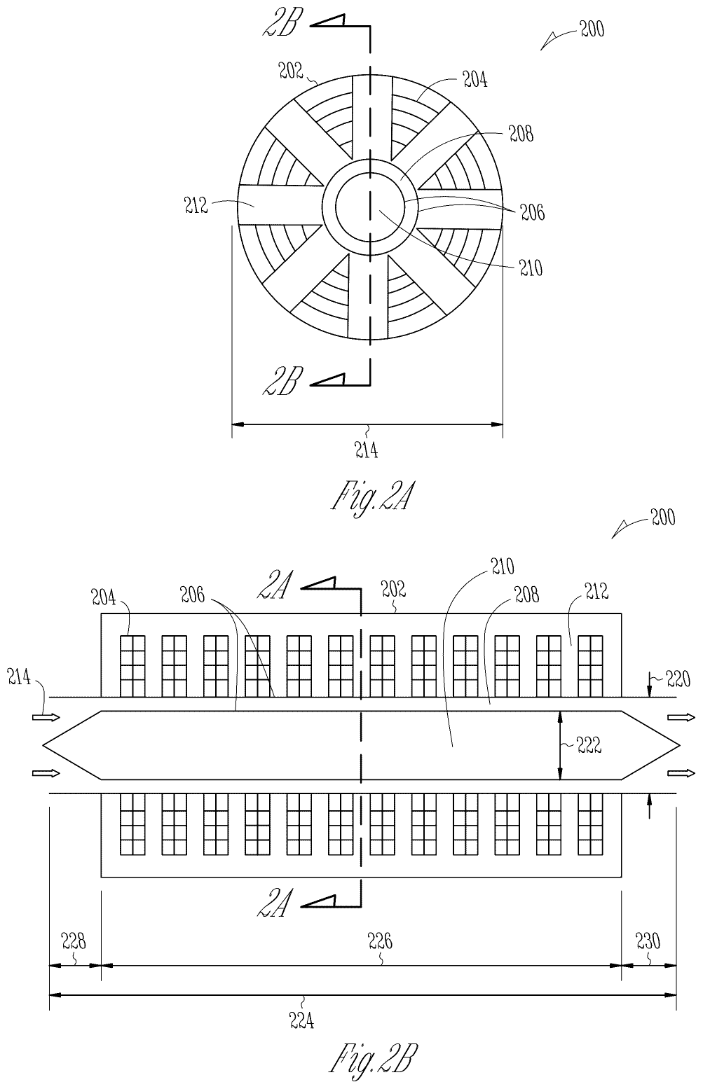

FIG. 2A shows a radial cross-sectional view of an annular linear induction pump 200, in accordance with one or more example implementations. The annular linear induction pump 200 can include a casing 202 with a plurality of coils 204 disposed within the casing 202. The annular linear induction pump 200 can also include an annular duct 208 having duct walls 206. Additionally, the annular linear induction pump 200 can include a center component 210. In various examples, a plurality of stators 212 can extend radially with respect to the center component 210 and the annular duct 208.

The casing 202 of the annular linear induction pump 200 can be comprised of one or more stainless steel materials. In at least some examples, the one or more materials comprising the casing 202 can have a curie point from about 800° C. to about 1200° C., from about 900° C. to about 1100° C., from about 800° C. to about 900° C., from about 850° C. to about 950° C., from about 900° C. to about 1000° C., from about 950° C. to about 1050° C., from about 1000° C. to about 1100° C., from about 1050° C. to about 1150° C., or from about 1100° C. to about 1200° C. In still other examples, the one or more materials comprising the casing 202 can have a saturation magnetic field flux density from about 10 kiloGauss (kG) to about 40 KG, from about 15 KG to about 25 KG, from about 20 KG to about 30 kG, from about 25 kG to about 35 kG, or from about 30 kG to about 40 kG. In one or more additional examples, the walls of the annular duct 208 can be comprised of one or more stainless steel materials.

In one or more examples, the center component 210 can be comprised of one or more metallic materials. In at least some examples, the center component 210 can be comprised of laminated metal sheets stacked radially with conical extensions to guide liquid flow through the annular duct 208. In one or more additional examples, the center component 210 can be comprised of one or more metallic materials having from about 30% by weight to about 60% by weight iron, from about 30% by weight to about 40% by weight iron, from about 35% by weight to about 45% by weight iron, from about 40% by weight to about 50% by weight iron, from about 45% by weight to about 55% by weight iron, or from about 50% by weight to about 60% by weight iron. The center component 210 can also be comprised of one or more metallic materials having from about 30% by weight to about 60% by weight cobalt, from about 30% by weight to about 40% by weight cobalt, from about 35% by weight to about 45% by weight cobalt, from about 40% by weight to about 50% by weight cobalt, from about 45% by weight to about 55% by weight cobalt, or from about 50% by weight to about 60% by weight cobalt. Additionally, the center component 210 can be comprised of one or more materials having from about 0.1% by weight to about 5% by weight vanadium, from about 0.5% by weight to about 3% by weight vanadium, from about 0.5% by weight to about 1.5% by weight vanadium, from about 1% by weight to about 2% by weight vanadium, from about 1.5% by weight to about 2.5% by weight vanadium, and from about 2% by weight to about 3% by weight vanadium. In at least some examples, the center component 210 can include from about 0.001% by weight to about 1% by weight carbon or from about 0.05% by weight to about 0.5% by weight carbon and from about 0.01% by weight to about 1% by weight niobium. In one or more illustrative examples, the center component 210 can be comprised of one or more metallic materials including from about 45% by weight to about 55% by weight iron, from about 45% by weight to about 55% by weight cobalt, from about 1.5% by weight to about 2.5% by weight vanadium, from about 0.005% by weight to about 0.05% by weight carbon, and from about 0.01% by weight to about 0.1% by weight niobium. In one or more illustrative examples, the center component 210 can be comprised of a Hiperco 50 material.

In various examples, the core component 210 can have a diameter from about 10 mm to about 50 mm, from about 15 mm to about 40 mm, from about 10 mm to about 30 mm, from about 20 mm to about 40 mm, from about 5 mm to about 15 mm, from about 10 mm to about 20 mm, from about 15 mm to about 25 mm, from about 20 mm to about 30 mm, from about 25 mm to about 35 mm, or from about 30 mm to about 40 mm.

In one or more examples, the coils 204 can be comprised of metallic wires. In one or more illustrative examples, the metallic wires of the coils 204 can be comprised of at least one of copper or alloys of copper. In one or more additional illustrative examples, the metallic wires of the coils 204 can be comprised of at least one of aluminum or alloys of aluminum. In one or more further illustrative examples, the metallic wires of the coils 204 can be comprised of 13 American Wire Gauge (AWG) wire. In at least some examples, the coils 204 can be comprised of wire having diameters from about 0.5 mm to about 4 mm, from about 1 mm to about 3 mm, from about 0.5 mm to about 1.5 mm, from about 1 mm to about 2 mm, from about 1.5 mm to about 2.5 mm, from about 2 mm to about 3 mm, from about 2.5 mm to about 3.5 mm, or from about 3 mm to about 4 mm. In one or more further illustrative examples, the individual stators 212 can include from about 10 coils to about 100 coils, from about 20 coils to about 80 coils, from about 30 coils to about 60 coils, from about 20 coils to about 50 coils, from about 30 coils to about 60 coils, from about 40 coils to about 70 coils, or from about 50 coils to about 80 coils. In still other examples, the stators 212 can have from 20 to 80 slots, from 30 to 70 slots, from 40 to 60 slots, from 50 to 70 slots, or from 60 to 80 slots. In one or more examples, the number of turns per coil can be from about 20 to about 100, 30 to about 70, from about 20 to about 40, from about 30 to about 50, from about 40 to about 60, from about 50 to about 70, from about 60 to about 80, from about 70 to about 90, or from about 80 to about 100. In sill other examples, individual coils 204 can have a height from about 2 mm to about 20 mm, from about 5 mm to about 15 mm, from about 8 mm to about 12 mm, from about 10 mm to about 14 mm, or from about 12 mm to about 16 mm.

FIG. 2B shows an axial cross-sectional view of an annular linear induction pump 200, in accordance with one or more example implementations. The cross-sectional view of FIG. 2B shows the casing 202, the plurality of coils 204, and the annular duct 208 having duct walls 206. The cross-sectional view of FIG. 2B also shows the center component 210 and the stators 212. Additionally, the cross-sectional view of FIG. 2B shows the liquid flow 214 through the annular linear induction pump 200. The annular duct 208 can have an outer diameter 220 and an inner diameter 222. In various examples, the annular linear induction pump 200 can have a total pump length 224 with a pumping region length 226. Further, the annular linear induction pump 200 can include a first core extension 228 and a second core extension 230.

In one or more examples, the stators 212 can be comprised of one or more metallic materials having from about 30% by weight to about 60% by weight iron, from about 30% by weight to about 40% by weight iron, from about 35% by weight to about 45% by weight iron, from about 40% by weight to about 50% by weight iron, from about 45% by weight to about 55% by weight iron, or from about 50% by weight to about 60% by weight iron. The stators 212 can also be comprised of one or more metallic materials having from about 30% by weight to about 60% by weight cobalt, from about 30% by weight to about 40% by weight cobalt, from about 35% by weight to about 45% by weight cobalt, from about 40% by weight to about 50% by weight cobalt, from about 45% by weight to about 55% by weight cobalt, or from about 50% by weight to about 60% by weight cobalt. Additionally, the stators 212 can be comprised of one or more materials having from about 0.1% by weight to about 5% by weight vanadium, from about 0.5% by weight to about 3% by weight vanadium, from about 0.5% by weight to about 1.5% by weight vanadium, from about 1% by weight to about 2% by weight vanadium, from about 1.5% by weight to about 2.5% by weight vanadium, and from about 2% by weight to about 3% by weight vanadium. In at least some examples, the stators 212 can include from about 0.001% by weight to about 1% by weight carbon or from about 0.05% by weight to about 0.5% by weight carbon and from about 0.01% by weight to about 1% by weight niobium. In one or more illustrative examples, the stators 212 can be comprised of one or more metallic materials including from about 45% by weight to about 55% by weight iron, from about 45% by weight to about 55% by weight cobalt, from about 1.5% by weight to about 2.5% by weight vanadium, from about 0.005% by weight to about 0.05% by weight carbon, and from about 0.01% by weight to about 0.1% by weight niobium. In one or more illustrative examples, the stators 212 can be comprised of a Hiperco 50 material. In various examples, the stators 212 can be comprised of E-shaped metal sheets with insulation material disposed between the sheets. In one or more examples, the insulation material can encase at least a portion of the coils 204. In at least some examples, the insulation material can include one or more ceramic materials. In one or more illustrative examples, the insulation material can withstand a maximum voltage of 150 Volts AC at temperatures up to 1000° C. without failure. In one or more additional illustrative examples, the insulation material can withstand temperatures from 1100° C. to 1500° C. without failure. In one or more further illustrative examples, the insulation material can withstand temperatures from 500° C. to about 1000° C. without failure.

In one or more illustrative examples, the annular linear induction pump 200 can have from 2 poles to 12 poles, from 4 poles to 10 poles, from 6 poles to 12 poles, from 2 poles to 4 poles, from 3 poles to 5 poles, from 4 poles to 6 poles, from 5 poles to 7 poles, from 6 poles to 8 poles, from 7 poles to 9 poles, from 8 poles to 10 poles, from 9 poles to 11 poles, or from 10 poles to 12 poles. In various examples, the annular linear induction pump 200 can operate an terminal voltages from about 50 V to about 300 V, from about 100 V to about 200 V, from about 50 V to about 150 V, from about 100 V to about 200 V, from about 150 V to about 250 V, or from about 200 V to about 300 V. The annular linear induction pump 200 can also operate at current frequencies from about 25 Hz to about 250 Hz, from about 50 Hz to about 200 Hz, from about 50 Hz to about 100 Hz, from about 100 Hz to about 150 Hz, from about 150 Hz to about 200 Hz, or from about 200 Hz to about 250 Hz. In at least some examples, the annular linear induction pump 200 can have a pole pitch from about 50 mm to about 500 mm, from about 100 mm to about 300 mm, from about 300 mm to about 500 mm, from about 50 mm to about 150 mm, from about 100 mm to about 200 mm, from about 150 mm to about 250 mm, from about 200 mm to about 300 mm, from about 250 mm to about 350 mm, from about 300 mm to about 400 mm, from about 350 mm to about 450 mm, or from about 400 mm to about 500 mm.

In one or more examples, the annular linear induction pump 200 can have a length from about 500 mm to about 2500 mm, from about 1000 mm to about 2000 mm, from about 500 mm to about 1000 mm, from about 750 mm to about 1250 mm, from about 1000 mm to about 1500 mm, from about 1250 mm to about 1750 mm, or from about 1500 mm to about 2000 mm. An outer diameter of the annular linear induction pump 200 can be from about 20 mm to about 500 mm, from about 50 mm to about 250 mm, from about 50 mm to about 150 mm, from about 100 mm to about 200 mm, from about 150 mm to about 250 mm, from about 200 mm to about 300 mm, from about 250 mm to about 350 mm, from about 300 mm to about 400 mm, from about 350 mm to about 450 mm, or from about 400 mm to about 500 mm.

A thickness of the inner wall of the annular duct 208 can be from 0.1 mm to about 5 mm, from about 0.5 mm to about 2 mm, from about 0.5 mm to about 1.5 mm, from about 1 mm to about 2 mm, from about 1.5 mm to about 2.5 mm, from about 2 mm to about 3 mm, from about 2.5 mm to about 3.5 mm, from about 3 mm to about 4 mm, from about 3.5 mm to about 4.5 mm, or from about 4 mm to about 5 mm.

Flowrates through the annular linear induction pump 200 can be from about 1 kilogram (kg) of cooling fluid per second(s) to about 40 kg/s, from about 1 kg/s to about 20 kg/s, from about 2 kg/s to about 8 kg/s, from about 5 kg/s to about 10 kg/s, from about 10 kg/s to about 20 kg/s, from about 15 kg/s to about 25 kg/s, from about 20 kg/s to about 30 kg/s, from about 25 kg/s to about 35 kg/s, or from about 30 kg/s to about 40 kg/s. Pumping pressures with respect to the cooling fluids flowing through the annular linear induction pump 200 can be from 100 kiloPascals (kPa) to about 2000 kPa, from about 200 kPa to about 1000 kPa, from about 100 kPa to about 500 kPa, from about 250 kPa to about 750 kPa, from about 500 kPa to about 1000 kPa, from about 750 kPa to about 1250 kPa, from about 1000 kPa to about 1500 kPa, from about 1250 kPa to about 1750 kPa, or from about 1500 kPa to about 2000 kPa.

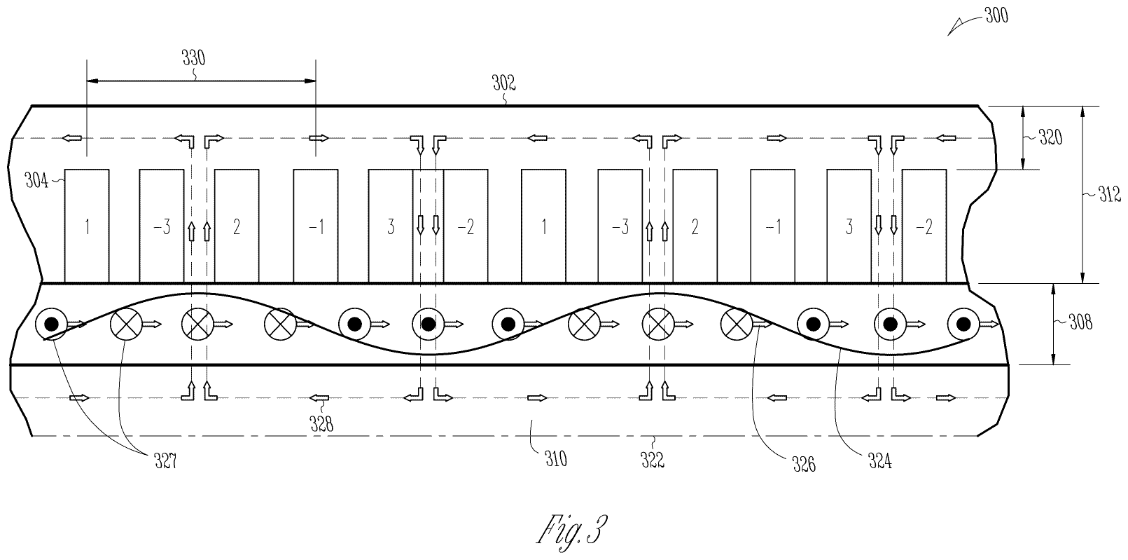

FIG. 3 is a diagram showing an axial cross-sectional view of a linear annular induction pump 300 that illustrates operation of the linear annular induction pump 300 in accordance with one or more example implementations. The linear annular induction pump 300 can include a casing 302 and a plurality of coils 304. The linear annular induction pump 300 can also include an annular duct 308, a center component 310 and stator 312. The produced sinusoidal magnetic fields are shown as 324 with directions indicated by arrows 328. Arrows 326 indicate the flow of fluid through the annular duct 308. Eddy currents 327 are also shown in the illustrative example of FIG. 3. In the illustrative example of FIG. 3, 322 represent a center line for the linear annular induction pump 300. Thus, the illustrative example of FIG. 3 shows a first half of the linear annular induction pump 300.

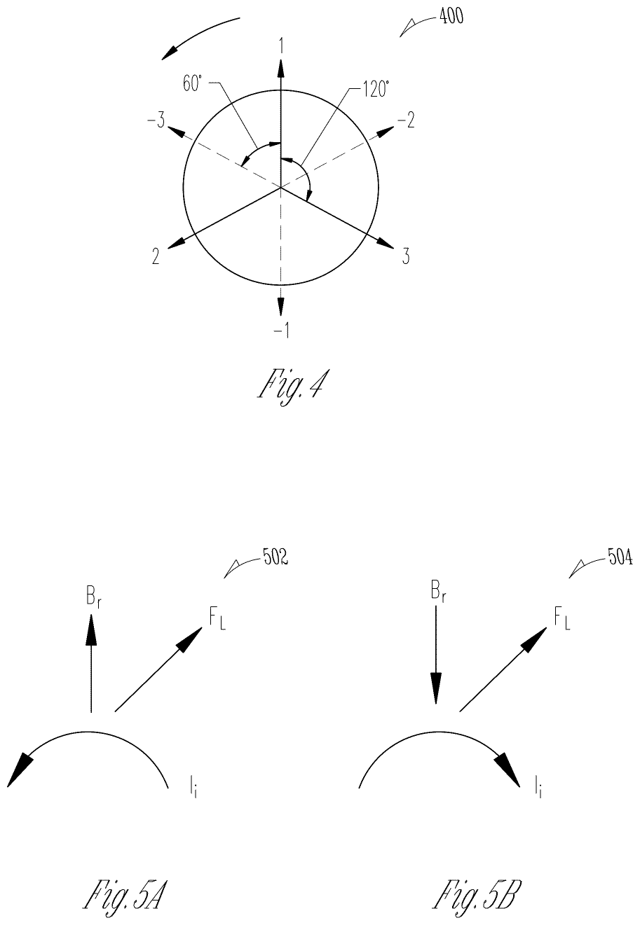

FIG. 4 shows at 400 the phase relationship of the coil connection with 3-phase power, in accordance with one or more example implementations. FIG. 5A shows at 502 that for pole 1 the magnetic field Br travels radially towards the stator and the eddy current Iᵢ travels circumferentially in a counter-clockwise direction, in accordance with one or more example implementations. FIG. 5B shows at 504 that for pole 2 the magnetic field Br travels radially toward the center core and Iᵢ travels circumferentially in a clockwise direction.

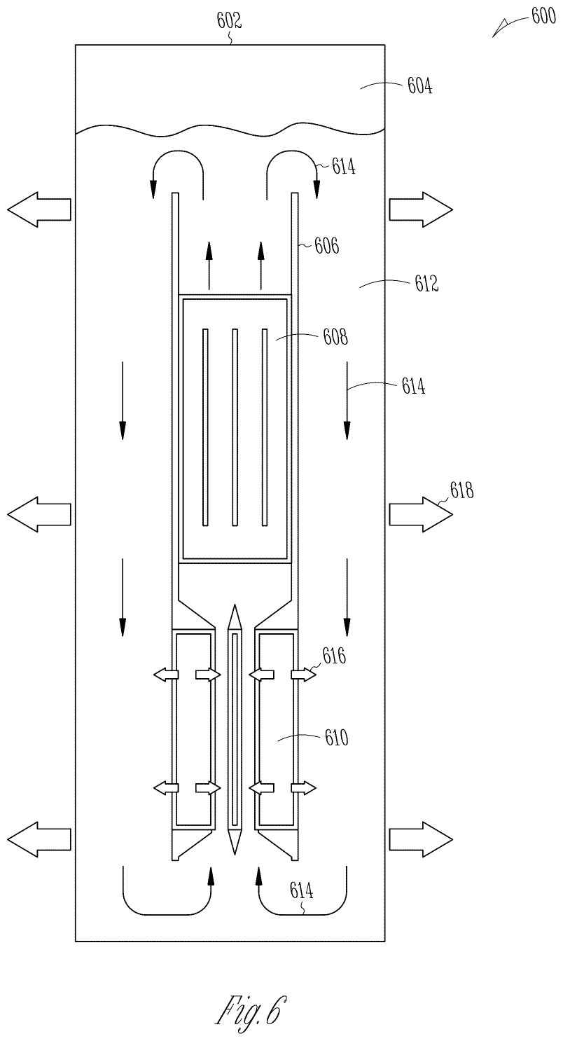

FIG. 6 is a diagram of a section of an in-pile test loop 600 that includes a riser tube 606 and an annular linear induction pump 610, in accordance with one or more example implementations. The in-pile test loop 600 can include an inert cover gas plenum 604. Additionally, a test article 608 comprising a number of fuel rods can be disposed in the riser tube 606. Fluid can flow in the direction of the arrows 614 through a fluid flow area 612, which can also be referred to herein as a downcomer 612. Arrows 616 show the dissipation of thermal power out of the annular linear induction pump 610 and arrows 618 show the heat removal by forced convection from the walls of the in-pile test loop 600.

FIG. 7 is a 3-phase wiring configuration of a pole pair present in an annular linear conduction pump, in accordance with one or more example implementations. The 3-phase wiring configuration can include first phase circuitry 702, second phase circuitry 704, and third phase circuitry 706. A first alternating current source line 708 can connect a first junction between the first phase circuitry 704 and the second phase circuitry 706. Additionally, a second alternating current source line 710 can connect a second junction between the first phase circuitry 704 and the third phase circuitry 706. Further, a third alternating current source line 712 can connect a third junction between the second phase circuitry 702 and the third phase circuitry 704.

The first phase circuitry 702 can include a first coil 714 arranged in parallel with a second coil 718 and a third coil 716 arranged in parallel with a fourth coil 720. The second phase circuitry 704 can include a fifth coil 722 arranged in parallel with a sixth coil 726 and a seventh coil 724 arranged in parallel with an eighth coil 726. The third phase circuitry 706 can include a ninth coil 730 arranged in parallel with a tenth coil 736 and an eleventh coil 732 arranged in parallel with a twelfth coil 734. In various examples, coils arranged in parallel with respect to one another can correspond to a same pole. Poles having the same phase, but different poles are coupled in series, such as coils 714 and 716.

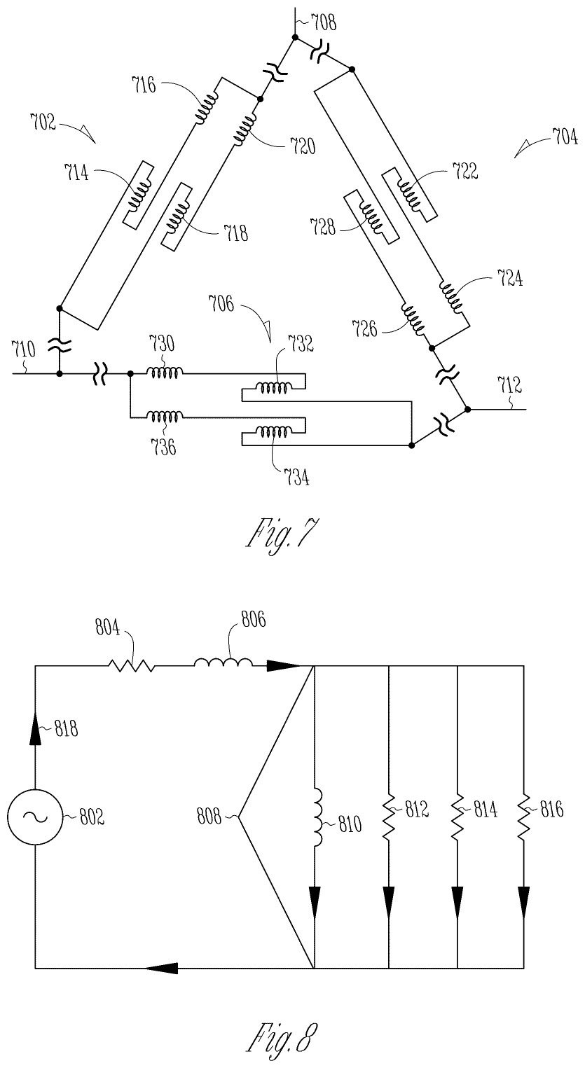

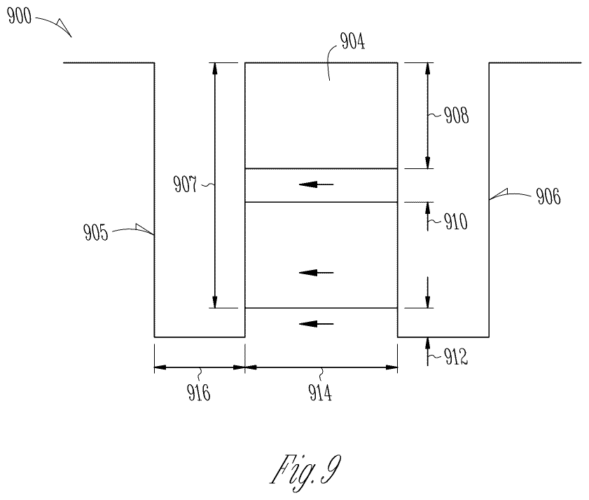

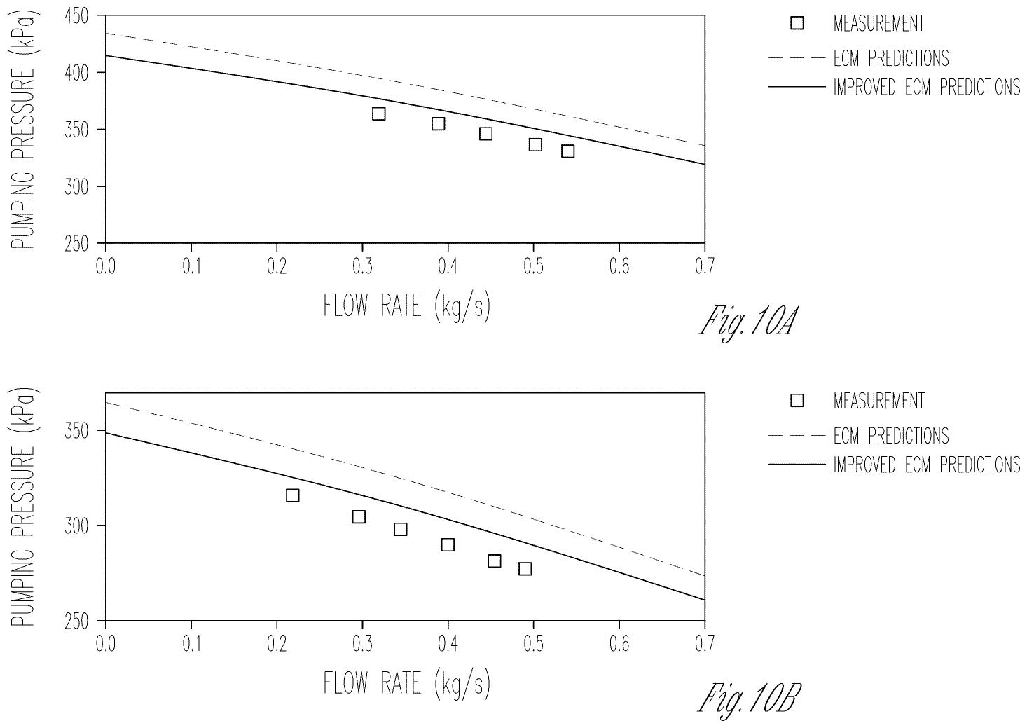

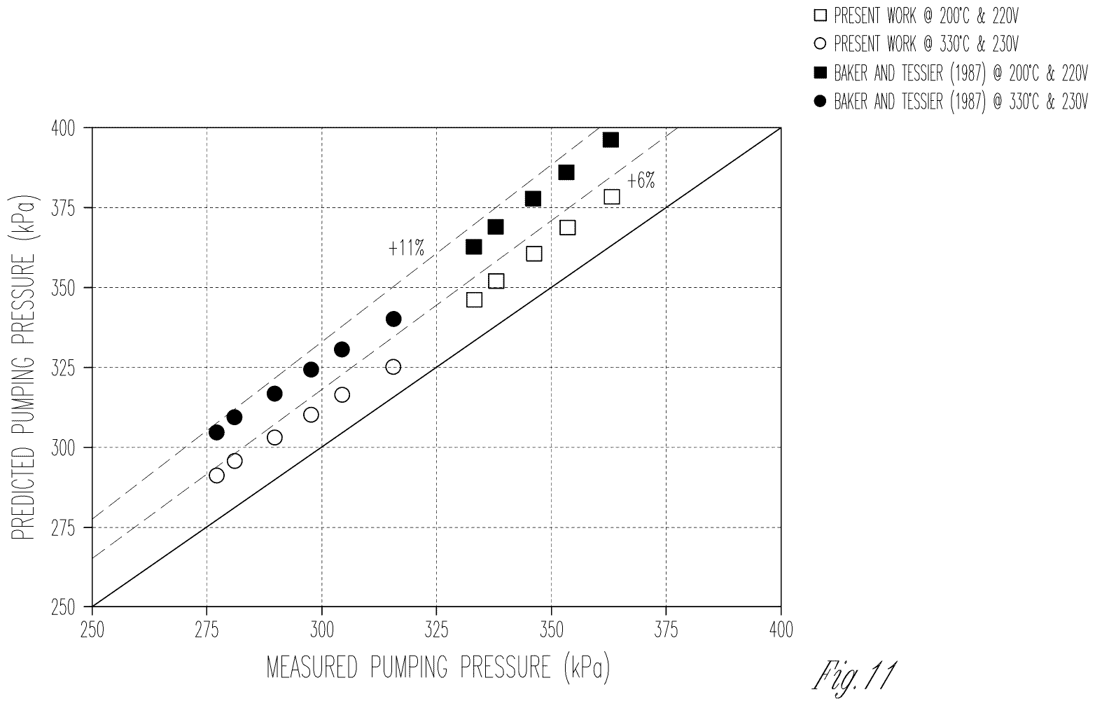

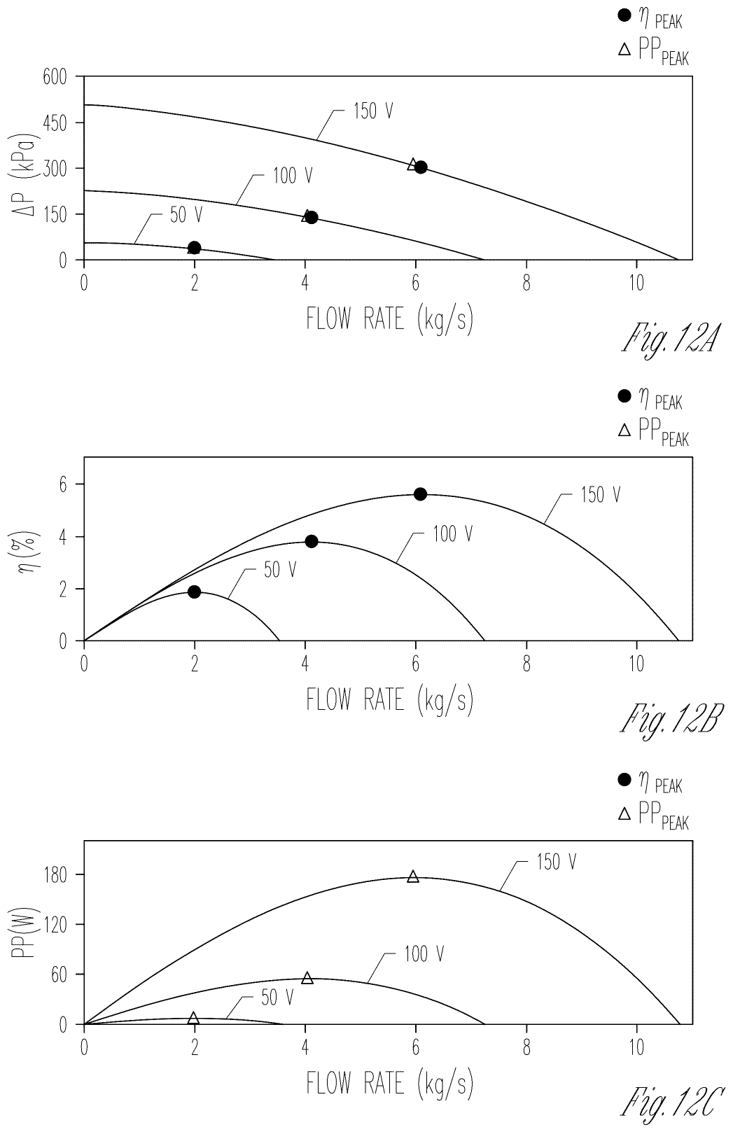

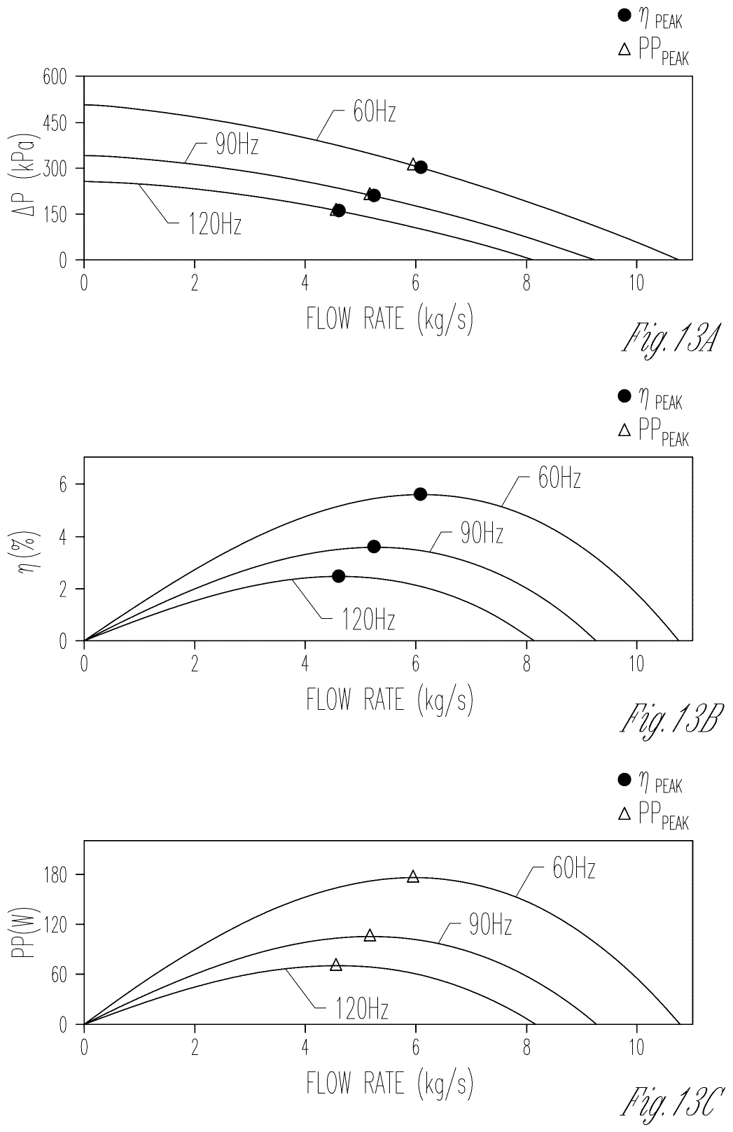

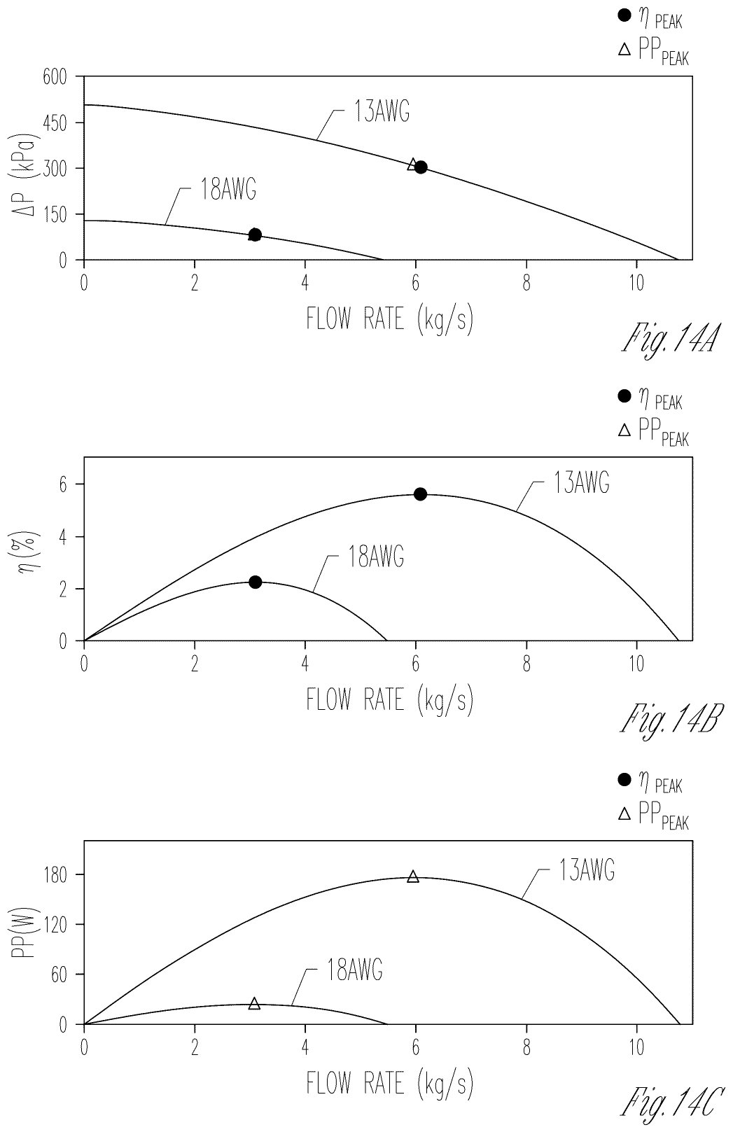

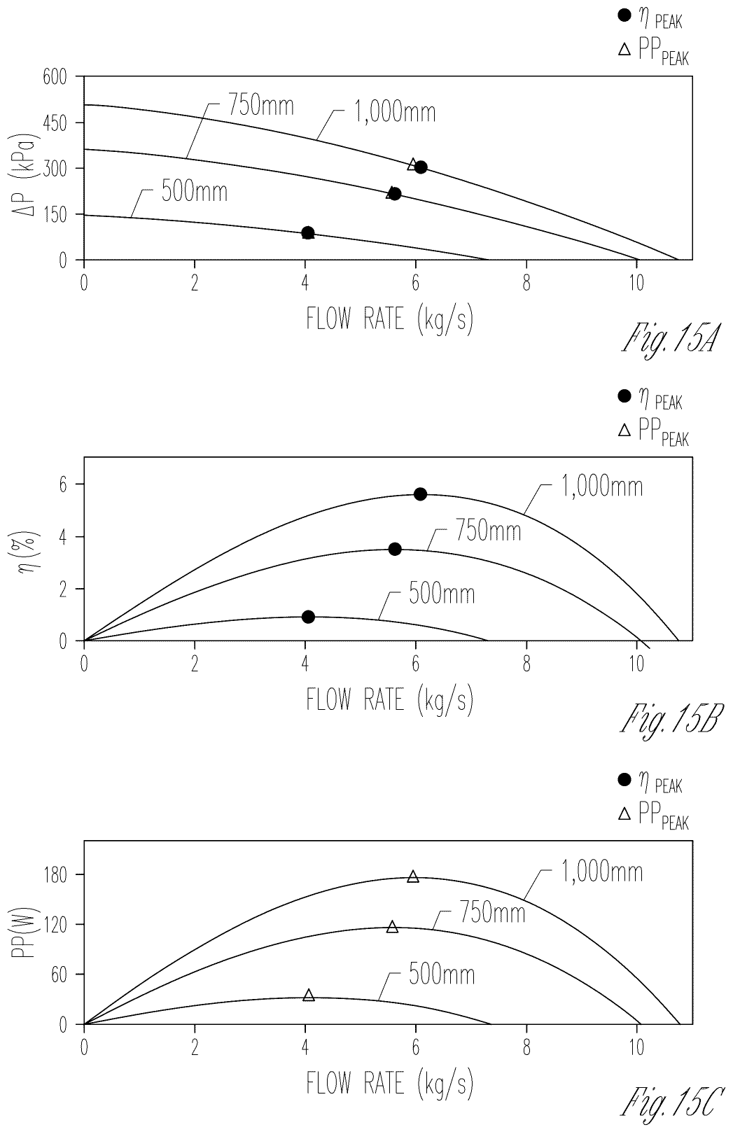

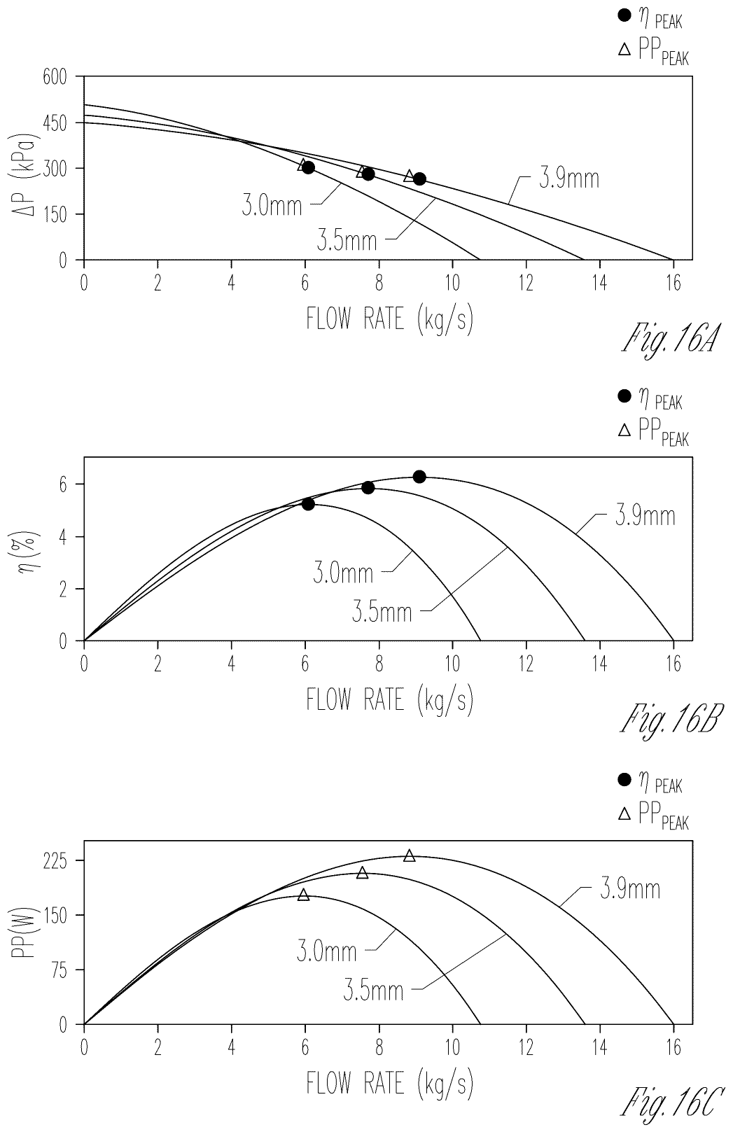

FIG. 8 is an electrical equivalent circuit diagram of an annular linear conduction pump, in accordance with one or more example implementations. The electrical equivalent circuit diagram includes a current source 802, a first resistance 804, and a first reactance 806. The first resistance can indicate a resistance of the winding coils (R_{c}). The first reactance 806 can indicate a stator leakage reactance (Xᵢ). Additionally, the electrical equivalent circuit diagram can indicate junctions at 808 and a second reactance 810. The second reactance can include a magnetizing reactance (Xₘ). Further, the electrical equivalent circuit diagram can include a second resistance 812, a third resistance 814, and a fourth resistance 816. The second resistance 812 can indicate a resistance of the inner wall of the annular duct (R_{iw}). The third resistance 814 can indicate a resistance of the fluid flowing through the annular duct (R_{wf}). The fourth resistance can indicate a resistance of the outer wall of the annular duct (R_{ow})

FIG. 9 is a diagram illustrating the leakage magnetic flux in a stator slot 900, in accordance with one or more example implementations. The illustrative example of FIG. 9 indicates a coil 904 and a first tooth 905 and a second tooth 906 of the stator. The illustrative example of FIG. 9 also shows the stator slot width 914. Leakage currents are characterized in FIG. 9 including a leakage flux passing through a winding coil and a leakage flux passing through the slot clearance 912. The coils can have a height 907 and a slot clearance 910. In the illustrative example of FIG. 9, 914 corresponds to the stator slot width and 916 corresponds to the stator tooth width. The stator slot width 916 can be from about 5 mm to about 25 mm, from about 5 mm to about 20 mm, from about 8 mm to about 12 mm, from about 10 mm to about 14 mm, from about 12 mm to about 16 mm, from about 16 mm to about 20 mm, or from about 18 mm to about 22 mm. The stator tooth width can be from about 2 mm to about 20 mm, from about 5 mm to about 15 mm, from about 5 mm to about 8 mm, from about 6 mm to about 9 mm, from about 7 mm to about 10 mm, from about 8 mm to about 11 mm, from about 9 mm to about 12 mm, from about 10 mm to about 13 mm, from about 11 mm to about 14 mm, or from about 12 mm to about 15 mm.

FIG. 10A-10B shows a comparison of the predictions of an improved equivalent circuit model (ECM) according to implementations described herein and a previously proposed ECM to experimental results for a low-flow sodium annular linear induction pump.

FIG. 11 shows overpredictions of annular linear induction pumps using an improved ECM according to implementations described herein and a previously proposed ECM compared to reported experimental results for a low sodium flow annular linear induction pump.

FIG. 12A-12C indicates calculated performance of an annular linear induction pump according to one or more example implementations described herein for circulating molten lead at 500° C. for different terminal voltages.

FIG. 13A-13C indicates calculated performance of an annular linear induction pump according to one or more example implementations described herein for circulating molten lead at 500° C. for different supplied current frequencies.

FIG. 14A-14C indicates calculated performance of an annular linear induction pump according to one or more example implementations described herein for circulating molten lead at 500° C. using ceramic insulated coil wires at different diameters.

FIG. 15A-15C indicates calculated performance of an annular linear induction pump according to one or more example implementations described herein for circulating molten lead at 500° C. using different lengths of the center core.

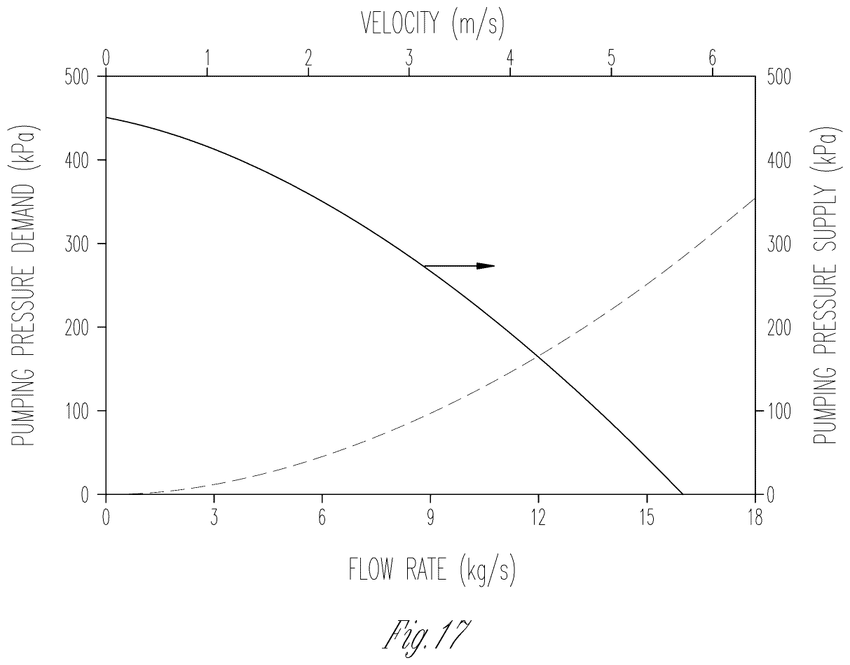

FIG. 16A-16C indicates calculated performance of for circulating molten lead at 500° C. for different widths of the annular flow an annular linear induction pump duct according to one or more example implementations described herein.

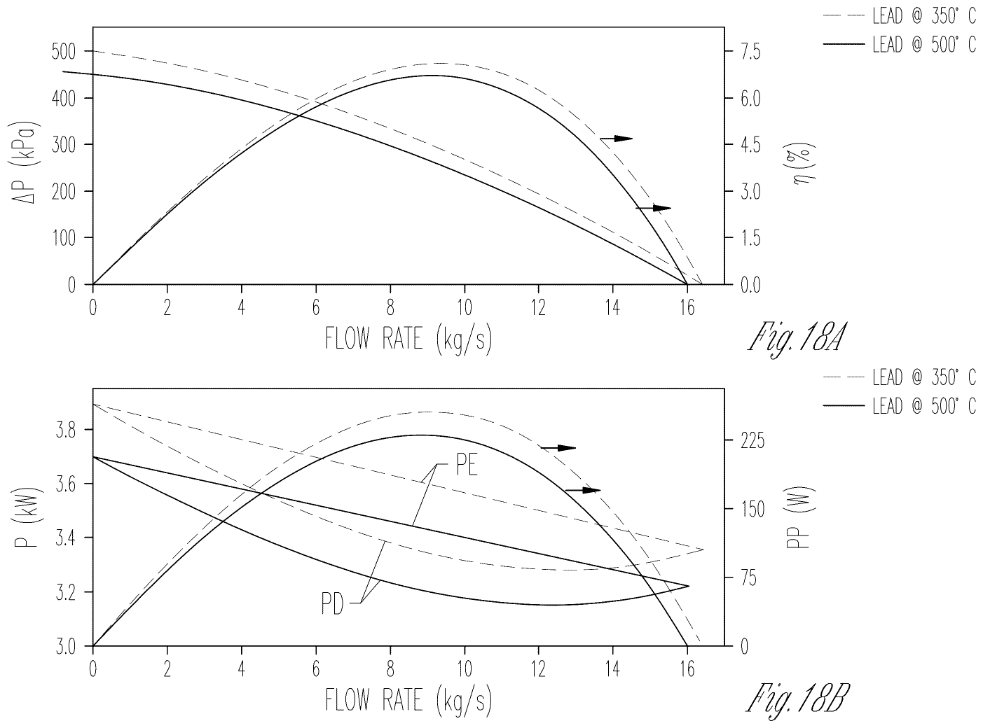

FIG. 17 shows a comparison of the calculated supply curve by an annular linear induction pump according to one or more example implementations described herein and the demand curve for a VTR molten lead test loop as a function of the flow rate.

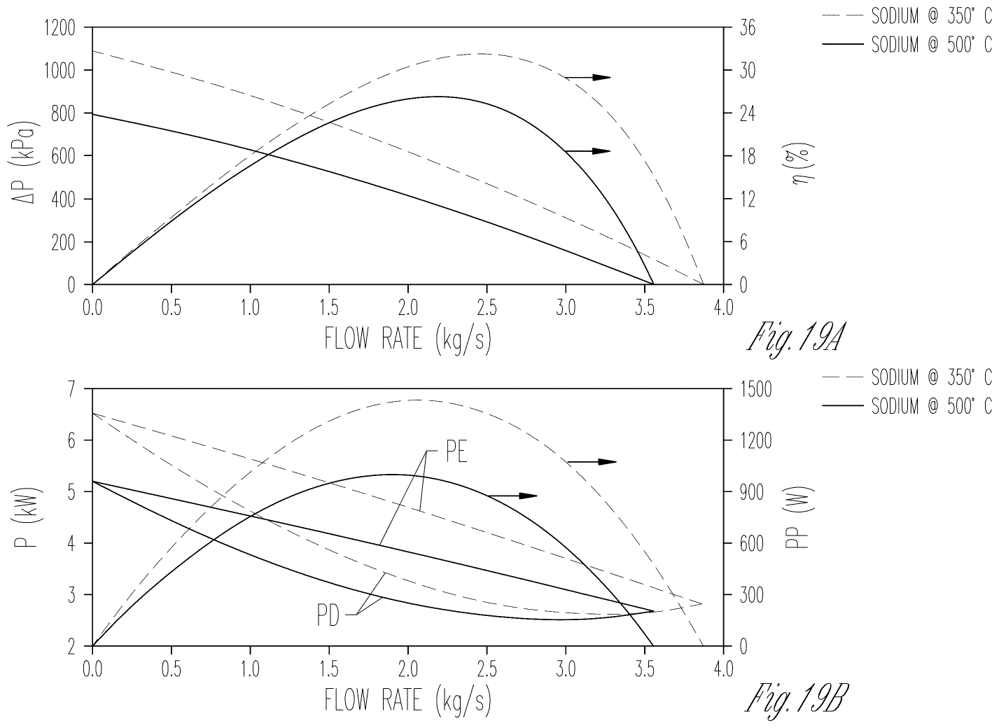

FIG. 18 indicates the effect of molten lead temperature on performance of annular linear induction pumps according to one or more example implementations described herein.

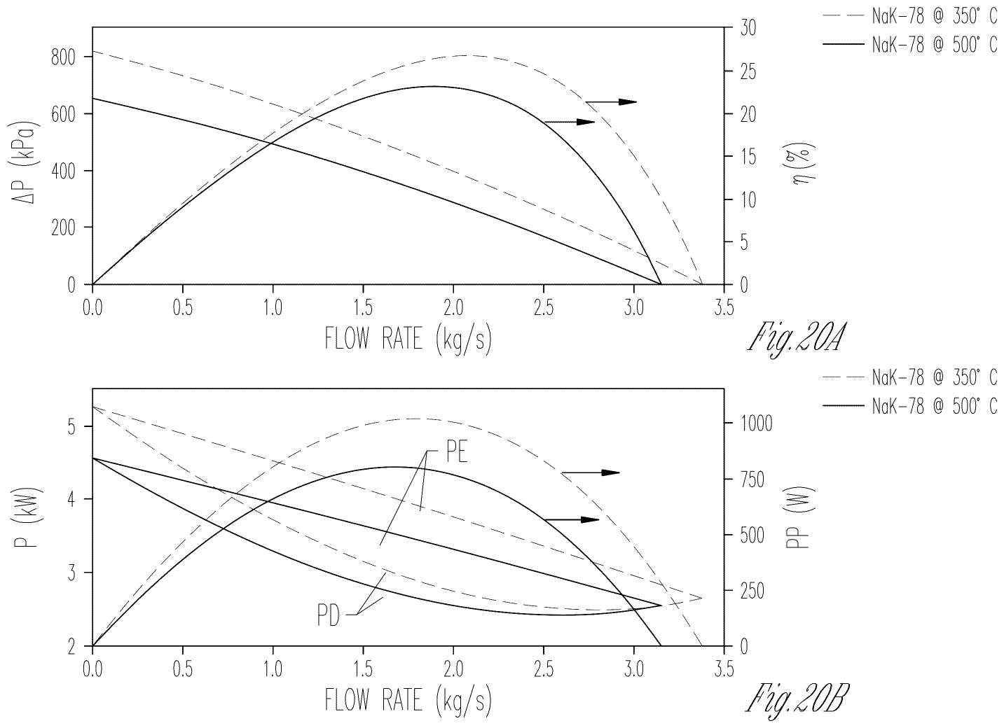

FIGS. 19A and 19B indicates the effect of liquid sodium temperature on the performance of annular linear induction pumps according to one or more example implementations described herein.

FIGS. 20A and 20B indicates the effect of liquid NaK-78 temperature on the performance of annular linear induction pumps according to one or more example implementations described herein.

An ALIP consists of two major parts, an electromagnet, and an annular duct for the flow of an electrically conductive fluid (FIG. 2). The electromagnet components include the center core and stators and the electrically insulated winding coils for 3-phase alternating current (FIG. 2). The laminated E-shaped metal sheets of the stators, made of high magnetic permeability, curie temperature and saturation magnetic field flux density material, are stacked together with insulation in between. The cylindrical center core of the electromagnet is fabricated of laminated metal sheets stacked in the radial direction and shaped with conical extensions for guiding the liquid flow entering and exiting of the annular gap surrounding the core.

The winding coils of high electrical conductivity material, such as copper, with electrical insulation capable of withstanding temperatures up to 500° C. are compatible with the working fluids of interest. The selected 316 SS for the inner and outer cylindrical walls of the annular flow duct is also compatible with the alkali and heavy liquid metals of interest at ≤500° C. The metal casing of the present submersible ALIP (FIG. 2) seals and protects components from the circulated liquid in the test loop.

FIG. 3 presents a cross-sectional elevation view showing the different components in an ALIP. The casing for the present ALIP is of the same material as that of the flow duct walls. The liquid metal flow along the surface of the casing or forced convection cooling methods can be used to removes the generated thermal power by joule heating in the winding coils of the ALIP. This power is rejected from the downcomer of the VTR liquid sodium in-pile test loop to the circulating sodium coolant of the reactor on the outer surface of the downcomer wall (e.g., FIG. 1). In an out-of-pile test loop, however, external cooling using either forced convection of water or atmospheric air can remove the Joule heating thermal power generated by the ALIP during operation.

An ALIP is powered by the symmetric 3-phase alternating currents, with a 120° phase shift, flowing through the winding coils with a 60° shift between neighbouring coils (FIGS. 3 and 4). The current flow in each of the winding coils produces a magnetic field, Bᵢ, that surrounds the coils and travels radially through both the stators tooth and the annular flow duct, and axially through the stators back and the center core. The core serves as a return path for the generated magnetic field. The produced sinusoidal magnetic fields by the winding coils, Bᵣ, in the annular flow duct (FIG. 3) travel axially commensurate with the frequency of the supplied electric current in the winding coils. According to Faraday's law of electromagnetic induction, the traveling magnetic fields will also produce eddy currents, Iᵢ, in the walls of the flow annulus and the working fluid in it. These currents travel in the circumferential directions and generate secondary magnetic fields that oppose the main traveling magnetic field in the flow duct (FIG. 3). The interaction of the circumferentially traveling induced currents and the radially traveling magnetic fields in the flow duct generates Lorentz force, Fr, in the perpendicular direction. This force drives the working fluid through the annular flow duct (FIG. 3).

The pairs of the magnetic poles in the ALIP, which are of the same length, r, are defined based on the direction of the radially traveling magnetic field through the flow duct. The produced magnetic field by the first magnetic pole travels from the center core towards the stator, while that produced by the other magnetic pole travels in the opposite direction from the stator towards the center core (FIG. 3). The pole pairs are periodically repeated along the axial direction of the flow every 360° shift in the winding coils (FIGS. 3 and 4). The induced electrical currents in the flow duct by the first magnetic pole type travel circumferentially in the counterclockwise direction and those induced by the other magnetic pole type travel in the clockwise direction. Although the two pole types have opposite directions to those of the traveling magnetic field and of the induced electrical currents, the generated Lorentz forces are in the same direction as the flowing fluid (FIG. 5). The sum of the Lorentz forces generated in all poles produce the pumping pressure for flowing the working fluid through the annular duct of the ALIP.

Varying the terminal voltage and the electrical current frequency changes the magnitude of the generated Lorentz force and hence, the pumping pressure. Both are directly proportional to the applied terminal voltage and inversely proportional to the frequency of the supplied electrical current. The liquid metal in the ALIP does not directly contact any parts of the pump, except the walls of the annular flow duct. Furthermore, the absence of moving parts increases the reliability and robustness of the ALIP, and the hermetic seal improves operation safety.

The developed miniature submersible ALIP in the present work, for circulating alkali liquid metals and heavy metal, has an outer diameter of 66.8 mm to fit in the riser tube of the test loop, with 1-mm wide radial clearance (FIG. 1). The riser tube is made of a 2.5-inch standard schedule five pipe with 68.8 mm inner diameter (FIG. 2). This ALIP can be mounted in the riser tube downstream of the test article of multiple nuclear fuel rodlets (FIGS. 1 and 6). The upper inert gas plenum in the VTR molten lead test loop (FIG. 1) accommodates the volume changes of the circulating liquid metals with temperature. Typically, cooling the ALIPs maintains the temperature below that recommended for the electrical insulation of the conducting winding coils. This temperature usually ranges from 120° C. to 150° C. However, in the present miniature submersible ALIP design for operating at higher temperatures up to 500° C., the selected Copper/Nickel winding coils have ceramic insulation. The ceramic insulation withstands a maximum voltage of 150 VAC for continuous operation up to 1000° C. without failure. These ceramic-insulated coil wires can also withstand exposure to neutrons and gamma rays without altering their mechanical properties. The ceramic insulation, however, limits the minimum bending diameter of the wires in the winding coils. The present miniature submersible ALIP uses a 13AWG wire (˜1.83 mm in diameter) in the winding coils.

The downsides of using this small-diameter winding wires are the high electrical resistance and the joule heating rate (or thermal power dissipation) and the low electric current input per phase. To alleviate these limitations and increase the electric current per phase, at the same terminal voltage, the present ALIP design uses a 3-phase delta connection of two parallel coils per phase per pole as shown in FIG. 7. In this arrangement, each two AC source lines (A, B, and C) are linked together by two parallel wires. Coils of the same phase in the same pole (e.g., coils #1 and 2) are connected in parallel, while coils of the same phase but different poles are connected in series (e.g., coils #1 and 7). Using two parallel wires halves the total electrical resistance and increases the electrical current passing through the coils, hence, enhancing the overall performance of the ALIP. Other selected materials for the present ALIP include SS-316 for the walls of the annular flow duct and pump casing, and Hiperco-50 for the center core and outer stator (FIGS. 2, 3). The non-magnetic SS 316 avoids disturbing the generated traveling magnetic field in the pump. In addition, its high electrical resistance decreases losses of the induced electrical current outside the liquid flow annulus. The SS-316, one of the most stable and commonly used stainless-steel types [18], is compatible with alkali metals and molten lead at up to 500° C. The 2-3% molybdenum content enhances corrosion resistance and improves mechanical strength at elevated temperatures.

The Hiperco-50 in the present ALIP design (FIGS. 2, 3) has desirable properties at elevated temperatures. It has a curie point of ˜940° C. and one of the highest saturation magnetic field flux densities, Bₛₐₜ, of all soft magnet materials of ˜24.5 KG. The high saturation magnetic flux density helps reduce the size of the stators and of the inner core, and hence the ALIP outer diameter (FIG. 6). By contrast, the widely used silicon steel increases the size of the stator size by ˜120% compared to that of the Hiperco-50 for the same magnetic field flux density. Furthermore, Hiperco-50 is compatible with high radiation exposure and has been used in ALIP designs for nuclear reactor applications. Table 2 lists the main operational and geometrical parameters of the present miniature, submersible ALIP design. It has six poles per stator, each consists of six coils divided into three phases, and operates at commercial current frequency of 60 Hz. The center core is 16 mm in outer diameter (FIG. 2). This diameter provides sufficient cross-section area for the magnetic field return path without reaching or exceeding the saturation magnetic flux density for the Hiperco-50 during ALIP operation. Similarly, the height of the stator back, δ_{sb}, is sufficiently large (FIGS. 2, 3) to pass the generated magnetic field in the stator without reaching the saturation magnetic flux density of Hiperco-50. In the present ALIP design, the magnetic flux density passing through the center core and the back stator is limited to 90% of the saturation flux density for Hiperco-50. The listed outer diameter and total length of the present submersible ALIP design are suitable for uses in out-of-pile and in-pile test loops that support the development of advanced GEN-IV nuclear reactors.

The submersible ALIP for circulating molten lead and alkali liquid metals of sodium and NaK-78 at temperatures up to 500° C. in test loops supporting the development for advanced GEN-IV nuclear reactors. The present 66.8 mm diameter ALIP design employs high-temperature ceramic insulated wires for the winding coils and Hiperco-50 for the center core and the stators to maximize the magnetic flux density without exceeding the saturation flux density in the back stators and center core. The performance characteristics of the present ALIP design are calculated using an improved ECM, which is developed in the present work and has shown to enhance the accuracy of the predictions. The improved ECM incorporates an equation for calculating the leakage reactance in the stator slot for the actual ALIP geometry, rather than a simplified expression based of a linear induction motor as in the ECM originally proposed by Baker and Tessier [1]. The comparison of the predictions of the improved ECM to the reported experimental measurements by other investigators for low liquid sodium flow ALIP at 200° C. and 330° C., confirmed the accuracy of the improved ECM. It overpredicted the ALIP characteristics by ˜6%, compared to 11% to 25% using the ECM proposed by Baker and Tessier

Parametric analyses of the performance of the present miniature, submersible ALIP design investigated the effects of the ALIP performance of varying the terminal voltage, the electrical current frequency, the diameter of the ceramic insulated Cu wires in the winding coils, the length of the center core, the width of the liquid flow annulus and the properties of the circulated liquids of molten lead, sodium and NaK-78. Performance parameters calculated include the cumulative pumping power, the pump efficiency, and the thermal power generated by Joule heating with increased flow rate. For achieving the highest efficiency and pumping pressure of the present 66.8 mm diameter ALIP, the selected operation and design parameters are terminal voltage of 150 VAC, current frequency of 60 Hz, winding wire size in coils of 13 AWG, 1,000 mm long center core, and an annulus flow duct width of 3.9 mm.

The pumping power and efficiency for circulating molten lead using the present ALIP is much lower than for circulating both sodium and NaK-78, but the generated thermal power dur Joule heating is higher, increasing the cooling requirements. For circulating molten lead at 500° C., the present ALIP has a peak pump efficiency of 6.7%, at a flow rate of 9.5 kg/s and pumping pressure of 263 kPa, which is significantly lower than those for circulating liquid sodium and NaK-78. For circulating liquid sodium and NaK-78 at 500° C., the peak efficiencies of the present ALIP are 26.3% and 23% and occur at flow rates of 2.2 kg/s and 1.9 kg/s and pumping pressures of 364 kPa and 310 kPa, respectively. Decreasing the circulated liquid temperature increases the ALIP pumping pressure, efficiency, and pumping power for the three liquids investigated, but at varying magnitudes, depending on the decreases in the electrical resistivities. The cooling requirement of the present ALIP design for circulating molten lead of 3.2 kW, is higher than those for circulating liquid sodium and liquid NaK-78, of 2.7 and 2.5 KW, respectively.

The present ALIP design and performance are suitable for uses in out-of-pile and in-pile test loops to support current and future developments of GEN-IV advanced molten lead-cooled reactors and sodium fast reactors for terrestrial power generations. The present ALIP design is also suitable for uses in nuclear reactor power systems, for space exploration and planetary surface power, and which employ NaK-78 liquid working fluid. For these applications, NaK-78 alloy with a low freezing temperature of −12° C., has been and still is an attractive choice for cooling the nuclear reactor and transporting waste heat from the energy conversion subsystem to heat pipe radiators to be radiatively rejected into space. The low melting temperature of the NaK-78 simplifies the power system design and integration by eliminating the need for adding an auxiliary subsystem to thaw the working fluid before starting up the nuclear reactor at planned destinations.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should, therefore not be limited by the above-described embodiments, methods, and examples, but by all embodiments and methods within the scope and spirit of the disclosure. Also, to the above description, the materials attached hereto form part of the disclosure of this provisional patent application.

### EXAMPLE OF THE DISCLOSURE

We developed novel design of submersible Annular Linear Induction Pump (ALIP) design with an outer diameter of 66.8 mm with appropriate materials is developed for circulating molten lead and alkali liquid metals of sodium and sodium-potassium-78 (NaK-78) alloy in test loops at temperatures up to 500° C. These loops investigate the compatibility of these liquid coolants with nuclear fuel and structure materials to support the development of advanced, GEN-IV nuclear reactors. The present ALIP, which employs high-temperature ceramic insulated coil wires and Hiperco-50 center core and stators, fits in 316 SS, 2.5-inch standard schedule five pipe. This pipe, considered for the riser tube of the Versatile Test Reactor (VTR) in-pile test cartridge loop, has an inner diameter of 68.8 mm permitting 1.0 mm radial clearance for the present ALIP. An improved Equivalent Circuit Model (ECM) is developed to analyse the performance of the present ALIP design. The accuracy of the model predictions is successfully validated using reported experimental measurements by other investigators for a low liquid sodium flow ALIP at 200° C. and 330° C. The improved ECM calculates the performance characteristics of the present ALIP design and investigates the effects of varying the terminal voltage, current frequency, winding wire diameter, center core length, the width of liquid flow annulus, and the working fluid properties and temperature on the pump operation. For circulating molten lead, the calculated peak efficiency of the present ALIP design of 6.7% occurs at a flow rate of 9.5 kg/s and pumping pressure of 263 kPa. The calculated peak efficiency for circulating liquid sodium is much higher, 26.3%, and occurs at lower flow rate of 2.2 kg/s but higher pumping pressure of 364 kPa. The calculated peak efficiency for circulating NaK-78 (23%), is lower than for sodium and occurs at lower flow rate and pumping pressure of 1.9 kg/s and 310 kPa, respectively.

### Introduction

The Annular Linear Induction Pumps (ALIPs) with no moving parts have been used for circulating liquid metals in test loops, various industrial applications, and space nuclear reactor power systems. The absence of moving parts prolongs the operation lives of the ALIPs and the sealed structure eliminates fluid leakage and decreases maintenance. Polzin et al. have designed and experimentally investigated the performance of an ALIP for circulating liquid NaK-78 at 125° C. to 525° C. in a test loop to support the development of the affordable fission surface power system for potential deployment on the lunar surface. The coils, in this ˜22 cm diameter pump, were cooled by forced convection of helium gas.

The highest measured pump efficiency for circulating liquid NaK-78 at 125° C., 120 VAC, 33 Hz was ˜6%, the measured pumping pressure at zero flow was 90 kPa and the highest flow rate was 20.5 m3/h.

Kim and Lee have designed and experimentally evaluated an ALIP for circulating liquid sodium at 150° C. in an experimental test loop to support the development of a prototype liquid metal reactor. This 30-cm diameter pump with asbestos bands for electrically insulating the ribbon-shaped coils' winding. When operated at terminal voltage of 227 VAC and current frequency of 60 Hz the ALIP produced a pumping pressure of 125 kPa at a flow rate of 3.6 m3/h. Nashine and Rao have designed and experimentally evaluated an ALIP for circulating liquid sodium at 350° C. to support the development of an Indian prototype Fast Breeder Reactor (FBR). This 59.0 cm diameter pump used external air-forced convection to maintain the temperature of the coils at 100-120° C. and avoid melting the electrical insulation and short-circuiting the coils. At a terminal voltage of 360 VAC and current frequency of 50 Hz, the measured net pumping pressure at a flow rate of 125 m³/h was 394 kPa and the corresponding pump efficiency was 18%

Kwak and Kim have designed and fabricated a medium size ALIP for circulating liquid sodium at 340° C. in an out-of-pile thermal-hydraulics test loop for supporting the development of a Korean FBR. The coils of this 46 cm diameter pump were cooled by forced convection of air. When operated at a terminal voltage of 391 VAC and a current frequency of 60 Hz, the measured net pumping pressure was four hundred kPa at a sodium flow rate of eighty-five m3/h and a pump efficiency of 25%.

While ALIP external cooling is readily used in out-of-pile test loops and industrial applications, using submersible ALIPs is preferable and more practical for in-pile test loops. It simplifies the design and operation of the loops and avoids having penetrations into the test reactor core for circulating an external coolant for the pump, such as helium. Ota et al. have designed and measured the performance of a submersible ALIP for circulating liquid sodium at 452° C. in the core of the Japanese pool-type FBR. This ALIP used electrically insulating but thermally conductive insulation comprised of layers of alumina and glass cloth and mica tape to transfer the dissipated thermal power by the pump to the circulating liquid sodium in the surrounding sodium pool. The 190 cm diameter and 440 cm long ALIP had a 7.7 cm wide liquid flow annulus for circulating liquid sodium at high flow rates. The ALIP performance has been evaluated for 2,550 hours in an experimental test facility. At a terminal voltage of 1,350 VAC and a current frequency of 20 Hz, the measured net pumping pressure was 250 kPa, at sodium flow rate of 9,600 m³/h and ALIP efficiency of 40%.

Nashine et al. have developed a submersible ALIP design for draining liquid sodium from the main vessel of the Indian FBR at temperatures up to 550° C. This submersible pump used copper winding wires with high-temperature inorganic mineral electrical insulation of magnesium oxide, MgO. The generated thermal power by joule heating in the wires during the operation of this 40 cm diameter ALIP was removed by the surrounding sodium flow. When this ALIP operated at terminal voltage of 150 VAC and current frequency of 50 Hz in sodium pool, the measured net pumping pressure at sodium flow rate of 2.0 m3/h was four hundred kPa.

These large-diameter submersible ALIPs are not suitable for uses in small-diameter out-of-pile and in-pile test loops. For these loops, miniature submersible ALIPs are preferable. Recently, preliminary designs of two in-pile test cartridge loops have been developed in the US for supporting the development of molten lead and liquid sodium-cooled Generation-IV reactors. These test loops were to be placed into the core of the Versatile Test Reactor (VTR) to investigate the compatibility of various nuclear fuel and structural materials and the prevailing corrosion mechanisms of these heavy and alkali liquid metals under prototypical temperature and radiation environment. The pool-type, sodium-cooled, three hundred MWth Versatile Test Reactor (VTR) is one-of-a-kind for performing large-scale, fast-neutron irradiation tests at elevated temperatures. Planned compatibility and corrosion tests with circulating molten lead were to initially be conducted with 316-stainless steel nuclear fuel cladding and structure material at temperatures up to 500° C. and then at higher temperatures with nickel-free steels such as FeCrAl or similar materials.

The objective of this work is to develop a submersible Annular Linear Induction Pump (ALIP) design with an outer diameter of 66.8 mm and appropriate choices of materials for circulating molten lead and liquid sodium at temperatures up to 500° C. in VTR test loops for supporting the development of GEN-IV nuclear reactors (Table 1). The developed ALIP design with high-temperature ceramic insulated coil wires and Hiperco-50 center core and stators fits in 316 SS, 2.5-inch standard schedule five pipe. This pump can be installed within the riser tube of the VTR molten lead in-pile test cartridge loop, with an inner diameter of 68.8 mm to allow 1.0 mm thick radial clearance. FIG. 1 presents a schematic of the VTR molten lead in-pile test loop. The present miniature submersible ALIP was to be placed in the riser tube, downstream of a test article of three fuel rodlets in a triangular lattice. To predict the performance parameters of the present ALIP design, this work developed and validated an improved Equivalent Circuit Model. The model predictions are compared to those of the widely used model introduced by Baker and Tessier and the reported experimental measurements by other investigators for a low sodium flow ALIP design. The improved ECM calculates the ALIP performance parameters and investigates the effects of varying the terminal voltage, current frequency, winding wire diameter, center core length, the width of the liquid flow annulus, and the working fluid properties and temperature (Table 1) on the pump characteristics. The analyses also determined the values of the pumping pressure and flow rate of the different working fluids for maximizing both the pump efficiency and the pumping pressure and calculated the values of the thermal power dissipated by the present ALIP. This power is removed by the circulating working fluid in the in-pile VTR test loop (FIG. 1) and rejected to the VTR primary sodium coolant flow along the outer surface of the test cartridge loop (FIG. 1).

TABLE 1
Comparison of molten lead, liquid sodium, and
liquid NaK -78 properties.

| | | | | | | *Specific |
|---|---|---|---|---|---|---|
| | Melt- | *Thermal | | | | heat |
| Work- | ing | conduc- | *Dynamic | | *Specific | capacity |
| ing | point | tivity | Viscosity | *Density | enthalpy | (KJ/ |
| fluid | (° C.) | (W/m · k) | (μ Pa · s) | (kg/m³) | (KJ/kg) | kg · K) |
| Pb | 327 | 17.7 | 1,814 | 10,452 | 32 | 0.144 |
| Na | 98 | 66.4 | 283 | 832 | 517 | 1.264 |
| NaK- | −12.6 | 26.3 | 192 | 748 | 457 | 0.873 |
| 78 | | | | | | |

*at 500 ° C.

### ALIP Operating Principle

An ALIP consists of two major parts, an electromagnet, and an annular duct for the flow of an electrically conductive fluid (FIG. 2). The electromagnet components include the center core and stators and the electrically insulated winding coils for 3-phase alternating current (FIG. 2). The laminated E-shaped metal sheets of the stators, made of high magnetic permeability, curie temperature and saturation magnetic field flux density material, are stacked together with insulation in between. The cylindrical center core of the electromagnet is fabricated of laminated metal sheets stacked in the radial direction and shaped with conical extensions for guiding the liquid flow entering and exiting of the annular gap surrounding the core. The winding coils of high electrical conductivity material, such as copper, with electrical insulation capable of withstanding temperatures up to 500° C. are compatible with the working fluids of interest. The selected 316 SS for the inner and outer cylindrical walls of the annular flow duct is also compatible with the alkali and heavy liquid metals of interest at <500° C. The metal casing of the present submersible ALIP (FIG. 2) seals and protects components from the circulated liquid in the test loop. FIG. 3 presents a cross-sectional elevation view showing the different components in an ALIP. The casing for the present ALIP is of the same material as that of the flow duct walls. The liquid metal flow along the surface of the casing or forced convection cooling methods can be used to removes the generated thermal power by joule heating in the winding coils of the ALIP. This power is rejected from the downcomer of the VTR liquid sodium in-pile test loop to the circulating sodium coolant of the reactor on the outer surface of the downcomer wall (e.g., FIG. 1). In an out-of-pile test loop, however, external cooling using either forced convection of water or atmospheric air can remove the Joule heating thermal power generated by the ALIP during operation.

An ALIP is powered by the symmetric 3-phase alternating currents, with a 120° phase shift, flowing through the winding coils with a 60° shift between neighboring coils (FIGS. 3 and 4). The current flow in each of the winding coils produces a magnetic field, Bᵢ, that surrounds the coils and travels radially through both the stators tooth and the annular flow duct, and axially through the stators back and the center core. The core serves as a return path for the generated magnetic field. The produced sinusoidal magnetic fields by the winding coils, Bᵣ, in the annular flow duct (FIG. 3) travel axially commensurate with the frequency of the supplied electric current in the winding coils.

According to Faraday's law of electromagnetic induction, the traveling magnetic fields will also produce eddy currents, Ii, in the walls of the flow annulus and the working fluid in it. These currents travel in the circumferential directions and generate secondary magnetic fields that oppose the main traveling magnetic field in the flow duct (FIG. 3). The interaction of the circumferentially traveling induced currents and the radially traveling magnetic fields in the flow duct generates Lorentz force, FL, in the perpendicular direction. This force drives the working fluid through the annular flow duct (FIG. 3).

The pairs of the magnetic poles in the ALIP, which are of the same length, r, are defined based on the direction of the radially traveling magnetic field through the flow duct. The produced magnetic field by the first magnetic pole travels from the center core towards the stator, while that produced by the other magnetic pole travels in the opposite direction from the stator towards the center core (FIG. 3). The pole pairs are periodically repeated along the axial direction of the flow every 360° shift in the winding coils (FIGS. 3 and 4). The induced electrical currents in the flow duct by the first magnetic pole type travel circumferentially in the counterclockwise direction and those induced by the other magnetic pole type travel in the clockwise direction. Although the two pole types have opposite directions to those of the traveling magnetic field and of the induced electrical currents, the generated Lorentz forces are in the same direction as the flowing fluid (FIG. 5). The sum of the Lorentz forces generated in all poles produce the pumping pressure for flowing the working fluid through the annular duct of the ALIP.

Varying the terminal voltage and the electrical current frequency changes the magnitude of the generated Lorentz force and hence, the pumping pressure. Both are directly proportional to the applied terminal voltage and inversely proportional to the frequency of the supplied electrical current. The liquid metal in the ALIP does not directly contact any parts of the pump, except the walls of the annular flow duct. Furthermore, the absence of moving parts increases the reliability and robustness of the ALIP, and the hermetic seal improves operation safety.

### Materials Selection and Coils Connection

The developed miniature submersible ALIP in the present work, for circulating alkali liquid metals and heavy metal, has an outer diameter of 66.8 mm to fit in the riser tube of the test loop, with 1-mm wide radial clearance (FIG. 1). The riser tube is made of a 2.5-inch standard schedule five pipe with 68.8 mm inner diameter (FIG. 2). This ALIP can be mounted in the riser tube downstream of the test article of multiple nuclear fuel rodlets (FIGS. 1 and 6). The upper inert gas plenum in the VTR molten lead test loop (FIG. 1) accommodates the volume changes of the circulating liquid metals with temperature. Typically, cooling the ALIPs maintains the temperature below that recommended for the electrical insulation of the conducting winding coils. This temperature usually ranges from 120° C. to 150° C. However, in the present miniature submersible ALIP design for operating at higher temperatures up to 500° C., the selected Copper/Nickel winding coils have ceramic insulation. The ceramic insulation withstands a maximum voltage of 150 VAC for continuous operation up to 1000° C. without failure. These ceramic-insulated coil wires can also withstand exposure to neutrons and gamma rays without altering their mechanical properties. The ceramic insulation, however, limits the minimum bending diameter of the wires in the winding coils. The present miniature submersible ALIP uses a 13AWG wire (˜1.83 mm in diameter) in the winding coils.

The downsides of using this small-diameter winding wires are the high electrical resistance and the joule heating rate (or thermal power dissipation) and the low electric current input per phase. To alleviate these limitations and increase the electric current per phase, at the same terminal voltage, the present ALIP design uses a 3-phase delta connection of two parallel coils per phase per pole as shown in FIG. 7. In this arrangement, each two AC source lines (A, B, and C) are linked together by two parallel wires. Coils of the same phase in the same pole (e.g., coils #1 and 2) are connected in parallel, while coils of the same phase but different poles are connected in series (e.g., coils #1 and 7). Using two parallel wires halves the total electrical resistance and increases the electrical current passing through the coils, hence, enhancing the overall performance of the ALIP.

Other selected materials for the present ALIP include SS-316 for the walls of the annular flow duct and pump casing, and Hiperco-50 for the center core and outer stator (FIGS. 2, 3). The non-magnetic SS 316 avoids disturbing the generated traveling magnetic field in the pump. In addition, its high electrical resistance decreases losses of the induced electrical current outside the liquid flow annulus. The SS-316, one of the most stable and commonly used stainless-steel types, is compatible with alkali metals and molten lead at up to 500° C. The 2-3% molybdenum content enhances corrosion resistance and improves mechanical strength at elevated temperatures.

The Hiperco-50 in the present ALIP design (FIGS. 2, 3) has desirable properties at elevated temperatures. It has a curie point of ˜940° C. and one of the highest saturation magnetic field flux densities, Bₛₐₜ, of all soft magnet materials of ˜24.5 kG. The high saturation magnetic flux density helps reduce the size of the stators and of the inner core, and hence the ALIP outer diameter (FIG. 6). By contrast, the widely used silicon steel increases the size of the stator size by ˜120% compared to that of the Hiperco-50 for the same magnetic field flux density. Furthermore, Hiperco-50 is compatible with high radiation exposure and has been used in ALIP designs for nuclear reactor applications.

Table 2 lists the main operational and geometrical parameters of the present miniature, submersible ALIP design. It has six poles per stator, each consists of six coils divided into three phases, and operates at commercial current frequency of 60 Hz. The center core is 16 mm in outer diameter (FIG. 2). This diameter provides sufficient cross-section area for the magnetic field return path without reaching or exceeding the saturation magnetic flux density for the Hiperco-50 during ALIP operation. Similarly, the height of the stator back, δsb, is sufficiently large (FIGS. 2, 3) to pass the generated magnetic field in the stator without reaching the saturation magnetic flux density of Hiperco-50. In the present ALIP design, the magnetic flux density passing through the center core and the back stator is limited to 90% of the saturation flux density for Hiperco-50. The listed outer diameter and total length of the present submersible ALIP design are suitable for uses in out-of-pile and in-pile test loops that support the development of advanced GEN-IV nuclear reactors.

TABLE 2
Operation and geometrical parameters of
present miniature, submersible ALIP.

| Parameter | Value | Parameter | Value |
|---|---|---|---|
| Working fluid | Pb, Na, | *Length of Pumping | 1,000 |
| | NaK-78 | region, Lₚ | |
| | | (mm) | |
| Operating Temp. (° C.) | 500 | Center core extension, | 50 |
| | | Lₑₓ (mm) | |
| *Terminal voltage (V) | 150 | Pole pitch, r (mm) | 167 |
| *Current Frequency (Hz) | 60 | Stator slot width, Wₛ | 17.5 |
| | | (mm) | |
| Pump outer diameter, | 66.8 | Stator tooth width, Wₜ | 10 |
| Dₒ(mm) | | (mm) | |
| Number of poles | 6 | Center core diameter, D_{iw} | 16 |
| | | (mm) | |
| Number of coils in the | 36 | Inner duct wall thickness | 1 |
| stator | | (mm) | |
| Coils per phase per pole | 2 | *Annular channel width, oₐ | 3.9 |
| | | (mm) | |
| Number of turns per coil | 40 | Outer duct wall thickness | 1.5 |
| | | (mm) | |
| *Winding wire Dia. | 13 | Coil height, oₑ (mm) | 11 |
| (AWG) | | | |
| Pump total length, L | 1,100 | Stator back depth, o_{sb} (mm) | 6 |
| (mm) | | | |

Analysed parameters.

### Improved Equivalent Circuit Model

A lumped ECM of the ALIPs is first proposed by Baker and Tessier and has been widely used to predict performance parameters. This model represents the ALIP components using an electric circuit with equivalent values of the electrical resistances and reactance. These include the electrical resistances of the winding coils, Re, the inner wall of the annular flow duct, Riw, the outer wall of the annular flow duct, Row, and the flowing fluid in the annular duct, Rwf, in addition to the stator leakage reactance, XI, and the magnetizing reactance, Xm, (FIG. 8). The values of these parameters are used in the ECM to estimate the induced voltage across the flow annulus, EA, and the developed pumping pressure, ΔPp, by the ALIP.

The equations in the ECM of Baker and Tessier to obtain the variables in the ALIP electromagnetic pumping pressure are based on the basic theory of a tube linear induction motor. These equations involve several simplifying assumptions, namely: (a) symmetric input power for the three phases; therefore, only one phase is analysed, and the results are applied to the remaining phases; (b) axisymmetric sinusoidal induced magnetic fields and electrical currents distributions in the annular flow duct; (c) continuous magnetic fields in the poles located at the two ends of the pump (FIGS. 2, 3); (d) uniform velocity of the liquid flow in the annular duct; (e) the tube linear induction motor equation expresses the stator slot leakage reactance, and (f) negligible magnetic field flux leakage outside the stator. The predictions of the ECM by Baker and Tessier overestimated the reported the experimental measurements for the ALIP designs of Kim and Lee, by <22.3%, Nashine and Rao, by <25%, Kwak and Kim, by <16%, Sharma et al., by <13%, and Nashine et al., by <11%. Nonetheless, owing to the simplicity and the low computational requirements and cost, the ECM by Baker and Tessier has been widely used by researchers to predict the performance of ALIPs and conduct parametric analyses to support design development.

To improve the ECM proposed by Baker and Tessier, this work derived and implemented a modified equation of the slot leakage reactance. This equation is based on the actual geometry of the ALIP stator, rather than a tube linear induction motor. The reported experimental data by Sharma et al. [23] for a low-flow sodium ALIP confirmed the enhanced accuracy of the improved ECM. It decreases the difference between the predicted performance characteristics and the reported experimental measurements by Sharma et al. (2019) for a low sodium flow ALIP from 11% using the ECM to 6% (FIG. 10A-10B). The next subsection presents the governing equations of the improved ECM, followed by that of the validation and performance analyses results of the present miniature, submersible ALIP.

### Governing Equations

The developed pumping pressure, ΔPp, based on the induced Lorentz force balance along the annular flow duct, as a function of the mass flow rate of the liquid in the annual duct, can be expressed, as [1]:

$$Δ {P}_{p} = ( \frac{{N}_{p} - 1}{{N}_{p} + 1} ) 3 \frac{{( {E}_{A} )}^{2} ( {Q}_{syn} - \frac{\dot{m}}{ρ} )}{{{R}_{wf} ( {Q}_{syn} )}^{2}} \qquad ( 1 )$$

In this expression, Np is the number of poles in the pump, Qsyn is the synchronous working fluid flow rate in (m3/s), m is the working fluid mass flow rate in (kg/s), and p is the density of working fluid in (kg/m3). In Eq. 1, the correction factor,

$$\frac{N p - 1}{N p + 1} ,$$

is used to account for the ALIP end-effect caused by generated the Lorentz force in reverse directions from the interaction of the traveling magnetic field and the eddy currents at the inlet and exit regions of the annular flow duct. The induced voltage across the flow annulus, EA, is calculated as (FIG. 8):

$${E}_{A} - \frac{{E}_{B}}{( \frac{1}{{x}_{{m}^{i}}} + \frac{1}{{R}_{iw}} + \frac{1}{{R}_{ow}} + \frac{s}{{R}_{wf}} ) ( {R}_{c} + {X}_{l} i ) + 1} \qquad ( 2 )$$

In this equation, EB is the pump terminal voltage in (V), and s is the slip ratio of working fluid relative to the traveling magnetic field. The expressions for calculating the electrical variables in Eq. 2 and FIG. 8 are given as:

$${X}_{m} = \frac{15.06 \times {10}^{- 6} f τ ( \overline{{D}_{a}} ) {( {N}_{t , p h} {k}_{p} {k}_{d} )}^{2}}{{δ}_{n m} {k}_{n m} {N}_{p}} \qquad ( 3 )$$

$${R}_{iw} = \frac{3 {ρ}_{w} π ( {D}_{iw} + {δ}_{iw} ) {( {N}_{t , p h} {k}_{p} {k}_{d} )}^{2}}{{δ}_{iw} τ {N}_{p}} \qquad ( 4 )$$

$${R}_{ow} = \frac{3 {ρ}_{w} π ( {D}_{ow} + {δ}_{ow} ) {( {N}_{t , p h} {k}_{p} {k}_{d} )}^{2}}{{δ}_{ow} τ {N}_{p}} \qquad ( 5 )$$

$${R}_{wf} = \frac{3 {ρ}_{wf} π ( \overline{{D}_{a}} ) {( {N}_{t , p h} {k}_{p} {k}_{d} )}^{2}}{{δ}_{a} τ {N}_{p}} \qquad ( 6 )$$

$${R}_{c} = \frac{{ρ}_{c} {l}_{t} {N}_{t , c} {N}_{c , p h}}{{A}_{c} {N}_{w , p}} \qquad ( 7 )$$

In these expressions, f is the current frequency in (Hz), τ is the pole pitch in (m), D-a- is the mean diameter of flow annulus in (m), Nt,ph is the number of winding turns of the coil per phase, kp is the pitch factor, kd is the winding distribution factor, onm is the total non-magnetic gap width in (m), knm is a multiplier factor for non-magnetic gap width, Np is the number of the poles in the ALIP, pw is the electrical resistivity of the annular flow duct walls in (Ω·m), Diw is the inner diameter of the annular flow duct wall in (m), oiw is the wall thickness of the annular flow duct inner wall in (m), Dow is the inner diameter of the outer flow duct wall in (m), oow is the thickness of the annular duct outer wall in (m), pwf is the electrical resistivity of working fluid in (Ω·m), oa is the width of the annular flow channel in (m), pe is the electrical resistivity of the winding conductor in (Ω·m), It is the average length of the winding turn of the coil in (m), Nt,c is the number of winding turns per coil, Nc,ph is the number of coils per phase in the stator, Ae is the cross-section area of the winding conductor in (m2), and Nw,p is the number of winding wires connected in parallel per phase.

An expression for calculating the slot leakage reactance, Xl, which represents the leakage of the primary magnetic flux from its main path to the stator slots, is derived in section IV. B and implemented in the Improved ECM used to predict the ALIP performance characteristics. This expression is given as:

$${X}_{l} = \frac{2 {π}^{2} f {μ}_{o} {N}_{t , c}^{2} {N}_{c , p h}}{{w}_{s}} ( \frac{{δ}_{c} {D}_{s} + 2 {δ}_{c} {δ}_{cl}}{3} + \frac{{δ}_{c}^{2}}{6} + {δ}_{cl} {D}_{s} ) \qquad ( 8 )$$

In this equation, μois the magnetic permeability of free space (H/m), Ws is the stator slot width in (m), oe is the coil height in (m), Ds is the stator's inner diameter in (m), and oel is the slot clearance height in (m) (FIGS. 2, 3). The net pumping pressure, ΔP, of the ALIP equals that produced by the Lorentz force, ΔPp, given by Eq. (1), minus the friction pressure losses, ΔPloss, of the flowing liquid in the pump annular duct, as:

$$Δ P = Δ Pp - Δ Ploss \qquad ( 9 )$$

The friction pressure losses are calculated using the Darcy-Weisbach equation, expressed as:

$$Δ {P}_{loss} = f \frac{l}{{D}_{h}} \frac{{\dot{m}}^{2}}{2 ρ {A}^{2}} \qquad ( 10 )$$

In this equation, f is the friction factor, l is the length of the annular flow duct in (m), Dh is the equivalent hydraulic diameter of the annular flow duct in (m), and A is the cross-section area of the annular flow duct in (m2). The empirical correlations of friction factor, f, proposed by Gnielinski for liquid flow in the annular duct of the ALIP are used in the present analyses. The friction factor for laminar flow (Re≤2,300) is calculated using the following expression:

$$f = \frac{64}{{R}_{e} ( \frac{( 1 + {a}^{2} ) ln ( a ) + ( 1 - {a}^{2} )}{{( 1 - a )}^{2} ln ( a )} )} \qquad ( 11 )$$

In this expression, Re is the liquid flow Reynold number, and a is the ratio of the inner to outer diameters of the annular flow duct. For turbulent flow (Re>7,000), the friction factor, f, is calculated, as:

$$f = ( 1.8 log {( {R}_{e} ( \frac{( 1 + {a}^{2} ) ln ( a ) + ( 1 - {a}^{2} )}{{( 1 - a )}^{2} ln ( a )} ) - 1.5 )}^{- 2} \qquad ( 12 )$$

In the transition flow region, 2,300<Re<7,000, the pressure losses are determined from the linear interpolation of the friction factor values for the laminar and turbulent flows determined from Eqs. 11 and 12, respectively. The ALIP pumping power, PP, input electric power, PE, and efficiency, 1], are calculated, respectively, using the following equations, as:

$$PP = Δ P Q \qquad ( 13 )$$

$$PE = \sqrt{3} {I}_{p} {E}_{B} {P}_{f} \qquad ( 14 )$$

$$η = 100 \% * \frac{Δ P Q}{\sqrt{3} {I}_{p} {E}_{B} {P}_{f}} \qquad ( 15 )$$

In these equations, Q is the volumetric flow rate of the working fluid in (m3/s), Ip is the phase current in (A), and Pf, is the pump power factor. The dissipated thermal power by joule heating during the ALIP operation, PD, to the flowing liquid in the test loop is taken equal to the difference between the electrical input power and the generated pumping power, as:

$$PD = PP - PE \qquad ( 16 )$$

### Derived Expression for the ALIP Slot Leakage Reactance

As shown in FIG. 9, the total leakage of magnetic flux from a stator slot in the ALIP consists of two components, namely: (a) the leakage flux passing through a winding coil, Φ1, and (b) the leakage flux passing through a slot clearance, Φ2. The corresponding leakage inductance components, L1 and L2, are used to calculate the ALIP total leakage reactance expressed, as:

$${X}_{l} = 2 π f ( {L}_{1} + {L}_{2} ) {N}_{c , ph} \qquad ( 17 )$$

In this expression, the leakage inductances in the coil, L1, is expressed as:

$${L}_{1} = {N}_{t , c} \frac{{ϕ}_{1}}{I} \qquad ( 18 )$$

At any strip, dx, the magnetic field, dcp1, may be expressed as:

$$d {ϕ}_{1} = \frac{amp - turns}{Reluctance} \qquad ( 19 )$$

In this expression, the amp-turns, and the reluctance at strip, dx, are given, respectively, as:

$$amp - turns = {IN}_{t , c} \frac{x}{{δ}_{c}} , \qquad ( 20 )$$

$$and ,$$

$${S}_{dx} = \frac{Length of flux flow}{{μ}_{0} * Area of flux flow} = \frac{{W}_{s}}{{μ}_{0} π ( {D}_{s} + 2 {δ}_{cl} + 2 {δ}_{c} - 2 x ) dx} \qquad ( 21 )$$

Therefore, the magnetic flux, dcp1, at strip, dx, is calculated as:

$${ϕ}_{1} = \frac{I {N}_{t , c} x {μ}_{0} π ( {D}_{s} + 2 {δ}_{cl} + 2 {δ}_{c} - 2 x ) dx}{{δ}_{c} {W}_{s}} \qquad ( 22 )$$

The leakage inductance at the strip, dx, may be expressed as:

$${dL}_{x} = {N}_{t , c} \frac{x}{{δ}_{c}} \frac{d {ϕ}_{1}}{I} = \frac{{N}_{t , c}^{2} {x}^{2} {μ}_{0} π ( {D}_{s} + 2 {δ}_{cl} + 2 {δ}_{c} - 2 x ) dx}{{δ}_{c}^{2} {W}_{s}} \qquad ( 23 )$$

To calculate L1, dLx is integrated along the coil height, dc, as:

$$( 24 )$$

$${L}_{1} = {\int }_{0}^{{δ}_{c}} {dL}_{l , 1} = \frac{{N}_{t , c}^{2} {μ}_{0} * π}{{W}_{s} {δ}_{c}^{2}} {\int }_{0}^{{δ}_{c}} {x}^{2} \cdot ( {D}_{s} + 2 {δ}_{cl} + 2 {δ}_{c} - 2 x ) dx = \frac{{N}_{t , c}^{2} {μ}_{0} * π}{{W}_{s}} ( \frac{{D}_{s} {δ}_{c} + 2 {δ}_{cl} {δ}_{c}}{3} + \frac{{δ}_{c}^{2}}{6} ) ,$$

All the coil turns, Nt,e, will contribute to the leakage flux in the slot clearance, φ2, expressed as:

$${ϕ}_{2} = \frac{I {N}_{t , c}}{\frac{{W}_{s}}{{μ}_{0} π {D}_{s} {δ}_{cl}}} = I {N}_{t , c} \frac{{μ}_{0} π {D}_{s} {δ}_{cl}}{{W}_{s}} \qquad ( 25 )$$

The leakage inductance is then calculated as:

$${L}_{2} = {N}_{t , c} \frac{{ϕ}_{2}}{I} = \frac{{N}_{t , c}^{2} {μ}_{0} π}{{W}_{s}} {D}_{s} {δ}_{cl} \qquad ( 26 )$$

Substituting Eq. (24) and Eq. (26) into Eq. (17) and multiplying by the number of phases, the expression for calculating the ALIP total leakage reactance (Eq. 17) is given as:

$${X}_{l} = \frac{2 {π}^{2} f {μ}_{0} {N}_{t , c}^{2} {N}_{c , ph}}{{W}_{s}} ( \frac{{δ}_{c} {D}_{s} + 2 {δ}_{c} {δ}_{cl}}{3} + \frac{{δ}_{c}^{2}}{6} + {δ}_{cl} {D}_{s} ) \qquad ( 27 )$$

This equation is incorporated in the improved ECM used to conduct parametric and performance analyses of the present miniature, submersible ALIP design for circulating heavy and alkali liquid metals. The next section presents the results confirming the accuracy of the ALIP improved ECM developed in this work.

### Accuracy of the ALIP Improved Equivalent Circuit Model

The constitute equations of the improved ECM are solved used the capabilities of the MATLAB platform. The physical and thermal properties of different pump components are assumed constant and equal to those evaluated at the inlet temperature (500° C.) of the flowing liquids of interest through the annular duct of the present ALIP design. Thus, the effect of increased liquid temperature due Joule heating is neglected. As shown latter in the results section, the rise in the temperatures of the circulated alkali and heavy liquid metals of interest in the present ALIP design is negligibly small to affect the ALIP operation (FIGS. 2, 3). The improved ECM predictions of the performance characteristics of Sharma et al. low sodium flow ALIP are compared to their reported experimental measurements. They used forced air cooling to maintain the temperature of coils in this ALIP below 200° C. The performed analysis of the Sharma et al. ALIP design using the improved ECM for the reported and listed dimensions and design details in Table 3.

TABLE 3
Reported operation and geometrical
parameters of low sodium flow ALIP.

| Operation parameter | Value | Geometrical parameters | Value |
|---|---|---|---|
| Working fluid | Sodium | Flow annulus width | 1.95 |
| | | (mm) | |
| Working fluid Temp. | 200-330 | Pole pitch (mm) | 132 |
| (° C.) | | | |
| Coils temperature (° C.) | <200 | Stator tooth width (mm) | 10 |
| Terminal voltage (V) | 220-230 | Stator slot width/height | 12/70 |
| | | (mm) | |
| Current frequency (Hz) | 50 | Total air gap (mm) | 10.55 |
| Total number of poles | 8 | Pump length (mm) | 1,066 |
| Total number of slots in | 48 | Pump outer diameter | ~254 |
| stator | | (mm) | |
| Turns per coil | 58 | Depth of back stator | 29 |
| | | (mm) | |

Sharma et al. reported two sets of measurements for their low sodium flow ALIP. The first set is for circulating sodium at 200° C. and a terminal voltage of 220 VAC, and the second is for circulating sodium at 330° C. and a terminal voltage of 230 VAC. FIGS. 10A and 10B compare the calculated performance characteristics of the low sodium flow ALIP, using both the improved ECM, developed in this work, and the ECM proposed by Baker and Tessier, to the reported experimental measurements by Sharma et al. Both models overpredict the pumping characteristics, but the predictions of the improved ECM are much closer to the reported experimental measurements. For both sets of measurements, the improved ECM overpredicts the performance data within 6% (FIG. 11), while the ECM of Baker and Tessier overpredicts the data by ˜11%. These comparisons confirm the increased accuracy of the improved ECM, used in the next section to perform parametric analyses of the present miniature submersible ALIP design (FIGS. 2, 3).

### Parametric Analyses Results

This section presents and discusses the results of performed parametric analyses of the present ALIP design for circulating molten lead, and sodium and NaK-78 liquids at inlet temperatures up to 500° C. Calculated are the pumping pressure and power and the pump efficiency with increased flow rate and the effect of temperatures on the performance characteristic of the present ALIP design. The obtained results, using Eqs. (9), (11), and (13), are for different values of the terminal voltage, electrical current frequency, winding coil diameter, length of the center core, and the width of the liquid flow annulus (FIG. 2). The values for the highest pump characteristics and efficiency are also determined. Operational and geometrical parameters used in the present ALIP performance analyses using the improved ECM are listed in Table 2.

### Parametric Analyses Results and Discussion

The pumping pressure of the ALIP increases proportional to the induced voltage in the annular flow duct, EA, hence, the pump terminal voltage, EB (Eqs. 1 and 2). Therefore, the terminal voltage strongly affects the performance characteristics of the ALIP. FIG. 12 compares the calculated characteristics of the present ALIP design at terminal voltages of 50, 100, and 150 VAC. Increasing the terminal voltage from 50 to 150 VAC increases the pumping pressure at zero flow from 57 to 510 kPa, and the highest flow rate of molten lead from 3.5 to 10.75 kg/s, respectively. This is in addition to increasing the pump peak efficiency 301%, from 1.86%, at pumping pressure of 35 kPa and molten lead flow rate of 2.0 kg/s, to 5.6% at pumping pressure of 302 kPa and flow rate of 6.1 kg/s (FIG. 12b). Also, the peak pumping power increases significantly from 6.8 W, at pumping pressure of 36 kPa and molten lead flow rate of 2.0 kg/s, to 176 W at pumping pressure of 309 kPa and flow rate of 5.95 kg/s (FIG. 12c). For the present miniature, submersible ALIP design, the terminal voltage is limited to a maximum of 150 VAC by the ceramic insulated coil wires.

The generated magnetic field in the stator, and hence the developed pumping pressure is inversely proportional to the frequency of the supplied electrical current to the ALIP coils (FIGS. 2, 3). FIG. 13 compares the calculated performance characteristics of present ALIP design for circulating molten lead at current frequencies of 60, 90, and 120 Hz. Decreasing the frequency from 120 to 60 Hz increases the pumping pressure at zero flow from 257 kPa to 510 kPa and the highest flow rate of molten lead from 8.1 to 10.75 kg/s, respectively. The corresponding peak efficiency of the ALIP increases as much as 227%, from 2.46% at pumping pressure of 160 kPa and molten lead flow rate of 4.6 kg/s to 5.6% at pumping pressure of 302 kPa and flow rate of 6.1 kg/s (FIG. 13b). The peak pumping power of the present ALIP also increases 248%, from 71 W at pumping pressure of 162 kPa and flow rate of 4.6 k g/s to 176 W at pumping pressure of 309 kPa and flow rate of 5.95 kg/s (FIG. 13c). Although decreasing the current frequency improves the performance of the ALIP, a frequency of 60 Hz is preferred to avoid limiting the generated magnetic field in the stator back (FIGS. 2, 3). At lower frequencies, the generated magnetic flux density in the stator back exceeds the saturation magnetic flux density of Hiperco-50.

The electrical resistance of the winding coils is inversely proportional to the diameter of the wire used (Eq. 7). Decreasing the electrical resistance of the winding coils wire using a large wire diameter increases the electrical currents in the coils, and hence the generated magnetic field and pumping pressure in the pump flow annulus. FIG. 14 compares the calculated performance characteristics of present ALIP design for circulating molten lead using winding coil with 13 and 18AWG conductor wire diameters of 1.0 and 1.83 mm, respectively. With the 13 AWG wire, the number of windings turns that fit in one coil equals forty, while it is as much as 135 with the 18 AWG wire. The increase in wire size from 18 to 13AWG increases the pumping pressure at zero flow of molten lead from 129 to 510 kPa, and the highest flow rate from 5.5 to 10.75 kg/s, respectively. Similarly, increasing the wire size from 18 to 13AWG increases the ALIP peak efficiency 251%, from 2.23%, at pumping pressure of 80 kPa and molten lead flow rate of 3.1 kg/s, to 5.6% at pumping pressure of 302 kPa and flow rate of 6.1 kg/s (FIG. 14b). The peak pumping power also increases 733%, from 24 W at pumping pressure of 81 kPa and flow rate of 3.1 kg/s, to 176 W at pumping pressure of 309 kPa and flow rate of 5.95 kg/s (FIG. 14c). The minimum bending diameter of the high-temperature ceramic insulated coil wires limits the wire size to be used in the present ALIP to a maximum of 13AWG. Larger wires require bending diameters larger than possible for the coils in the present 66.8 mm diameter submersible ALIP design.

With the same number of poles, the length of the ALIP center core increases proportional to the pole pitch and the induced voltage in the flow annulus. Increasing the center core length increases both the pumping pressure and the friction pressure losses, decreasing the net pumping pressure. FIG. 15 compares the calculated performance characteristics of the present ALIP design with different center core lengths of 500, 750, and 1,000 mm. Increasing the center core length from 500 to 1000 mm increases the pumping pressure at zero flow and the highest flow rate of molten lead from 147 to 510 kPa, and from 7.35 to 10.75 kg/s, respectively. Compared to the increase in the pumping pressure, that of the highest flow rate for the longer pump are smaller due to the increase in the friction pressure losses in the annular flow duct. Increasing the length of the center core from 500 to 1,000 mm increases the peak efficiency of the present ALIP design by 615%, from 0.91% at pumping pressure of 87 kPa and flow rate of 4.1 kg/s, to 5.6% at pumping pressure of 302 kPa and flow rate of 6.1 kg/s (FIG. 15b). The peak pumping power also increases 518%, from 34 W at pumping pressure of 87 k Pa and flow rate of 4.1 kg/s, to 176 W at pumping pressure of 309 kPa and molten lead flow rate of 5.95 kg/s (FIG. 15c). In the present ALIP design, the diameter of the center core is small relative to its length. The length of the center core is <1,000 mm to avoid deformation when operating at higher temperatures beyond 500° C.

The value of the magnetic circuit inductance for the ALIP is proportional to the cross-sectional area and inversely proportional to the length of the non-magnetic structure of the walls of the annular flow duct. For same inner and outer duct wall thicknesses, the total length of the air gap is linearly proportional to the width of the annular flow duct. Therefore, increasing the width of the annular flow duct decreases the magnetic flux density in the air gap and the generated Lorentz force in the duct. On the other hand, increasing the width of the annular flow duct decreases the friction pressure losses and increases the net pumping pressure.

FIG. 16 compares the calculated performance characteristics of the present ALIP design with annular flow duct widths of 3.0, 3.5, and 3.9 mm. Increasing the duct width from 3.0 mm to 3.9 mm decreases the pumping pressure of molten lead at zero flow from 510 to 450 kPa, due to the decrease in the magnetic flux density in the duct. On the other hand, the friction pressure losses in the 3.0 mm wide flow annulus increase in the highest flow rate of molten lead from 10.75 to 16.0 kg/s. Increasing the width of the flow duct to 3.9 mm increases the peak efficiency of the present ALIP design for circulating molten lead from 5.6% at pumping pressure of 30 2 kPa and flow rate of 6.1 kg/s to 6.7% at pumping pressure of 263 kPa and flow rate of 9.1 kg/s (FIG. 16b). The corresponding peak pumping power increases 31%, from 176 W at pumping pressure of 309 kPa and flow rate of 5.95 kg/s to 230 W at 272 kPa and 8.83 kg/s (FIG. 16c). With annular flow duct widths beyond 3.9 mm, the outer diameter of the present ALIP exceeds 66.8 mm and the magnetic flux density in the back stator exceeds the saturation magnetic flux density for the Hiperco-50. Thus, based on the presented and discussed performance results of the present ALIP design, the electrical and geometrical parameters for achieving the highest pump efficiency and pumping pressure are determined. These are a terminal voltage of 150 VAC, a current frequency of 60 Hz, a winding wire size of 13 AWG, a center core length of 1,000 mm, and an annulus flow duct width of 3.9 mm.

FIG. 17 presents the supply curve for the present miniature ALIP design and the demand curve for circulating molten lead at 500° C. in the VTR molten lead in pile test loop (FIGS. 1, 2). The intersection of these curves indicates a pumping pressure of 164 kPa at molten lead flow rate of 12.0 kg/s (flow velocity of 4.28 m/s). At these pumping pressure and flow rate, the pump efficiency of 5.68%, is 85% of the peak value. Circulating molten lead in the VTR test cartridge loop at 4.28 m/s does not induce flow instabilities due to the liquid high density and dynamic viscosity. The following subsection presents the results of investigating the effects of the liquid properties and temperatures on the operation characteristics of the present ALIP design.

### Effects of Liquid Properties and Temperatures on ALIP Performance

In addition to molten lead, the developed miniature, submersible ALIP can be used to circulate alkali liquid metals of sodium and NaK-78 alloy in test loops at inlet temperatures up to 500° C. This subsection investigates the effects of the circulating liquid properties and inlet temperature on the performance characteristics of the present ALIP design. The physical properties of molten lead and alkali liquid metals and of the pump structure materials are temperature dependent. Of particular interest are the electrical resistivity, dynamic viscosity, and density of these liquids, the electrical resistivity of the flow annulus wall material and the Cu wires, and the magnetic permeability of the stator and center core. Thus, changing the working fluid type or temperature would affect the ALIP performance. The analyses of the present ALIP design using the improved ECM investigated the effects of the properties of molten lead and of sodium and NaK-78 liquids and of decreasing the inlet temperature from 500° C. to 350° C. on the performance characteristics. The obtained performance results are for the pump dimensions listed in Table 2 and the selected parameters in the previous subsection, based on the parametric analyses results for achieving the highest pump characteristics for circulating molten lead at 500° C.

Table 4 compares the physical properties of molten lead, sodium, and NaK-78 at 500° C. and 350° C. Decreasing the temperature from 500° C. to 350° C. decreases the electrical resistivity of molten lead from 1.03 to 0.96 μΩ·m and those of liquids sodium and NaK-78 from 0.32 and 0.67 to 0.23 and 0.55 μΩ·m, respectively. A decrease in the electrical resistivity of the working fluid increases the induced currents in the annular flow duct and hence, the pumping pressure.

TABLE 4
Physical properties of molten lead
and liquid sodium at 350 and 500° C.

| | | Electrical | | |
|---|---|---|---|---|
| | Temperature | resistivity | Density | Viscosity |
| Working fluid | (° C.) | (μΩ · m) | (kg/m³) | (Pa · s) |
| Pb | 500 | 1.03 | 10,452 | 1,814 |
| | 350 | 0.96 | 10,644 | 2,531 |
| Na | 500 | 0.32 | 832 | 283 |
| | 350 | 0.23 | 868 | 367 |
| NaK-78 | 500 | 0.67 | 748 | 192 |
| | 350 | 0.55 | 783 | 259 |

Similarly, a decrease in the electrical resistivity of the Cu wire in winding coils with decreased temperature increases the phase current and the generated magnetic field by the coils, and hence, the pumping pressure. On the other hand, decreasing the temperature from 500° C. to 350° C. increases the dynamic viscosity of molten lead from 1,814 to 2,531 μPa·s and those of sodium and NaK-78 from 283 and 192 to 367 and 250 μPa·s, respectively (Table 4). The increase in the dynamic viscosity increases the friction pressure losses in the annular flow duct, decreasing the net pumping pressure and the highest flow rate achievable by the ALIP.

FIGS. 18-20 compare the calculated performance characteristics of the present miniature, submersible ALIP for circulating molten lead and alkali metals of sodium and NaK-78, at inlet temperatures of 350° C. and 500° C. For these fluids, the pumping pressure curves at 350° C. are higher than at 500° C. (FIGS. 18a, 19a, and 20a). The higher pumping curves are due to the decreases in the electrical resistivities of the circulated fluids with decreased temperature, increasing the induced electrical currents and the magnetic flux density in the pump flow duct.

For the present ALIP design, the phase electric current depends on the properties of the circulated fluid. The calculated phase currents and total rates of joule heating at 500° C. and the peak pump efficiencies are as follows: 24.9 A and 3.2 kW for molten lead, 25.5 A and 2.7 kW for Liquid Na and 24.85 A and 2.5 kW for liquid NaK-78. FIGS. 18-20 compare the calculated values of the generated thermal power in different fluids by Joule heating in the present ALIP design, as functions of the molten lead flow rate. Decreasing the molten Pb temperature from 500 to 350° C. increases the pumping pressure at zero flow 10.6%, from 450 kPa to 498 kPa and the highest flow rate only ˜2.5%, from 16.0 kg/s (flow velocity of 5.7 m/s) to 16.4 kg/s (flow velocity 5.8 m/s). At the same temperatures, the pumping pressures for circulating liquid sodium at zero flow are much higher than for molten lead. Decreasing the liquid sodium temperature from 500° C. to 350° C. increases the pumping pressure at zero flow 37.2%, from 796 to 1,092 kPa, and the highest flow rate 9%, from 3.55 kg/s (flow velocity of 16.6 m/s) to 3.87 kg/s (flow velocity of 15.9 m/s). For liquid NaK-78, decreasing the inlet temperature from 500° C. to 350° C. increases the pumping pressure at zero flow from 652 kPa to 818 kPa, and the highest flow rate from 3.15 kg/s (flow velocity of 16.0 m/s) to 3.38 kg/s (flow velocity of 15.7 m/s). The decreases in the electrical resistivities of sodium and NaK-78 with decreased temperature are much larger than for molten Lead, and the differences between the pumping pressure curves are also larger. As the flow rate increases, the difference between the calculated pumping pressures at 350° C. and 500° C. decreases for all three working fluids investigated (FIGS. 18a, 19a, and 20a). These decreases are due to the larger increase in the friction pressure losses at 350° C. compared to those at 500° C. At the same inlet temperature, the present submersible ALIP design for circulating liquid sodium produces the highest pumping pressure at zero flow because sodium has the lowest electrical resistance compared to those of liquid NaK-78 and molten lead. The later has the lowest pumping pressure at zero flow. On the other hand, the pumping pressure for circulating sodium and NaK-78 decrease faster than for molten lead with increased flow rate to smaller values of the highest flow rate. These are because at 500° C. and 350° C., the densities of liquids sodium and NaK-78 are only 12-14% of that of molten lead (Table 4).

Decreasing the operating temperature from 500° C. to 350° C. negligibly affects the present ALIP efficiency for circulating molten lead, compared to those for liquids sodium and NaK-78 (FIGS. 18a, 19a, and 20a). The peak efficiency for circulating molten lead increases with increased temperature from increased temperature from 350° C. to 500° C. from 6.7% to 7.1%, For sodium and Nak-78, the efficiency of the present ALIP design is much higher, increasing with increased temperature from 26.3% and 23.0% to 32.3% and 26.8%, respectively. Similarly, the corresponding peak pumping power of circulating molten lead increases from 230 W to 255 W, compared to 999 W and 760 W to 1,433 and 1,830 W for sodium and NaK-78, respectively (FIGS. 18b, 19b, and 20b).

The thermal power produced by Joule heating for circulating molten lead in the VTR in-pile test loop, FIG. 1, using the present ALIP design when operating at the peak efficiency is 3.2 KW. This thermal power is higher than those for circulating sodium and NaK-78 of 2.7 kW and 2.5 KW, respectively (FIGS. 18b, 19b, and 20b). The thermal power produced by the Joule heating in the pump coils is conducted to the circulating fluid in the test loop (Pb, Na, or NaK-78) and rejected in the downcomer (FIG. 1) to the primary Na coolant of the VTR. At the peak efficiency of the present ALIP design, the phase current passing through the winding coils is the highest for circulating liquid sodium (25.5A), compared to 24.85 A and 24.9 A for circulating liquid NaK-78 and molten lead, respectively.

In summary, decreasing temperature increases the pumping pressure, the highest flow rate, the ALIP efficiency, and the peak pumping power, however the magnitudes depend on the properties of the circulating fluid. At the same temperature, circulated liquids sodium and NaK-78 using the present ALIP experience higher pumping pressures at zero flow than molten lead. However, the pumping characteristic curves for sodium and NaK-78 decrease faster with increased flow rate to smaller values than for molten lead. The ALIP efficiency and pumping power curves for circulating molten lead at 350° C. and 500° C. are close, and the differences are much smaller than for circulating liquids sodium and NaK-78. Increasing temperature decreases the efficiency and pumping power of the present ALIP design and increases the thermal power produced by Joule heating in the pump coils primarily due to the increase in the electrical resistivities.

### SUMMARY AND CONCLUSIONS

This work developed a miniature, submersible ALIP for circulating molten lead and alkali liquid metals of sodium and NaK-78 at temperatures up to 500° C. in test loops supporting the development for advanced GEN-IV nuclear reactors. The present 66.8 mm diameter ALIP design employs high-temperature ceramic insulated wires for the winding coils and Hiperco-50 for the center core and the stators to maximize the magnetic flux density without exceeding the saturation flux density in the back stators and center core. The performance characteristics of the present ALIP design are calculated using an improved ECM, which is developed in the present work and has shown to enhance the accuracy of the predictions. The improved ECM incorporates an equation for calculating the leakage reactance in the stator slot for the actual ALIP geometry, rather than a simplified expression based of a linear induction motor as in the ECM originally proposed by Baker and Tessier. The comparison of the predictions of the improved ECM to the reported experimental measurements by other investigators for low liquid sodium flow ALIP at 200° C. and 330° C., confirmed the accuracy of the improved ECM. It overpredicted the ALIP characteristics by ˜6%, compared to 11% to 25% using the ECM proposed by Baker and Tessier.

Parametric analyses of the performance of the present miniature, submersible ALIP design investigated the effects of the ALIP performance of varying the terminal voltage, the electrical current frequency, the diameter of the ceramic insulated Cu wires in the winding coils, the length of the center core, the width of the liquid flow annulus and the properties of the circulated liquids of molten lead, sodium and NaK-78. Performance parameters calculated include the cumulative pumping power, the pump efficiency, and the thermal power generated by Joule heating with increased flow rate. For achieving the highest efficiency and pumping pressure of the present 66.8 mm diameter ALIP, the selected operation and design parameters are terminal voltage of 150 VAC, current frequency of 60 Hz, winding wire size in coils of 13 AWG, 1,000 mm long center core, and an annulus flow duct width of 3.9 mm.

The pumping power and efficiency for circulating molten lead using the present ALIP is much lower than for circulating both sodium and NaK-78, but the generated thermal power dur Joule heating is higher, increasing the cooling requirements. For circulating molten lead at 500° C., the present ALIP has a peak pump efficiency of 6.7%, at a flow rate of 9.5 kg/s and pumping pressure of 263 kPa, which is significantly lower than those for circulating liquid sodium and NaK-78. For circulating liquid sodium and NaK-78 at 500° C., the peak efficiencies of the present ALIP are 26.3% and 23% and occur at flow rates of 2.2 kg/s and 1.9 kg/s and pumping pressures of 364 kPa and 310 kPa, respectively. Decreasing the circulated liquid temperature increases the ALIP pumping pressure, efficiency, and pumping power for the three liquids investigated, but at varying magnitudes, depending on the decreases in the electrical resistivities. The cooling requirement of the present ALIP design for circulating molten lead of 3.2 KW, is higher than those for circulating liquid sodium and liquid NaK-78, of 2.7 and 2.5 kW, respectively.

The present ALIP design and performance are suitable for uses in out-of-pile and in-pile test loops to support current and future developments of GEN-IV advanced molten lead-cooled reactors and sodium fast reactors for terrestrial power generations. The present ALIP design is also suitable for uses in nuclear reactor power systems, for space exploration and planetary surface power, and which employ NaK-78 liquid working fluid. For these applications, NaK-78 alloy with a low freezing temperature of −12° C., has been and still is an attractive choice for cooling the nuclear reactor and transporting waste heat from the energy conversion subsystem to heat pipe radiators to be radiatively rejected into space. The low melting temperature of the NaK-78 simplifies the power system design and integration by eliminating the need for adding an auxiliary subsystem to thaw the working fluid before starting up the nuclear reactor at planned destinations.

What is claimed is:

1. An annular linear induction pump comprising:
a casing;
an annular duct disposed within the casing, the annular duct having an inner surface and an outer surface; and
an electromagnet comprising:
a center component located within the annular duct and forming the inner surface of the annular duct;
a plurality of stators disposed radially around the annular duct; and
a plurality of coils;
wherein the annular linear induction pump has an outer diameter from about 40 millimeters (mm) to about 100 mm and a length from about 800 mm to about 1500 mm.

2. The annular linear induction pump of claim 1, wherein:
the inner surface of the annular duct, the outer surface of the annular duct, and the casing are comprised of one or more stainless materials;
the plurality of coils are comprised of a copper-containing material; and
the center component and the plurality of stators are comprised of material comprising iron and cobalt.

3. The annular linear induction pump of claim 2, wherein one or more insulating materials are disposed between the plurality of stators, the one or more insulating materials being capable of withstanding decomposition when subjected to temperatures up to 500° C.

4. The annular linear induction pump of claim 3, wherein the one or more insulating materials include one or more ceramic insulating materials.

5. The annular linear induction pump of claim 1, wherein the plurality of coils are arranged axially along the annular duct with adjacent coils having a shift between about 50° to about 70°.

6. The annular linear induction pump of claim 1, wherein the plurality of coils are comprised of wires having diameters from about 1 mm to about 3 mm in diameter.

7. The annular linear induction pump of claim 1, wherein:
individual stators of the plurality of stators comprise a plurality of poles with individual poles of the plurality of poles having a plurality of coils divided into at least three phases;
individual coils of the plurality of coils have from about 15 turns to about 80 turns; and
the individual coils of the plurality of coils are comprised of a metallic wire having diameters from about 1 mm to about 3 mm.

8. The annular linear induction pump of claim 1, wherein the center component has an outer diameter from about 8 mm to about 20 mm.

9. The annular linear reduction pump of claim 1, wherein the annular linear reduction pump operates at terminal voltages from about 100 Volts (V) to about 300 V and at alternating current frequencies from about 30 Hertz (Hz) to about 90 Hz.

10. The annular linear reduction pump of claim 9, wherein the annular linear reduction pump operates with 3-phase alternating currents with a 120° phase shift at a frequency of about 40 Hz to about 60 Hz.

11. The annular linear reduction pump of claim 2 wherein said cylindrical center core of the electromagnet is fabricated of laminated metal sheets stacked in the radial direction and shaped with conical extensions for guiding the liquid flow entering and exiting of the annular gap surrounding the core.

12. The annular linear reduction pump of claim 1 wherein the pairs of the magnetic poles in the ALIP, which are of the same length, r, are defined based on the direction of the radially traveling magnetic field through the flow duct.

13. The annular linear reduction pump of claim 12, wherein the produced magnetic field by the first magnetic pole travels from the center core towards the stator, while that produced by the other magnetic pole travels in the opposite direction from the stator towards the center core.

14. The annular linear reduction pump of claim 12, wherein the pole pairs are periodically repeated along the axial direction of the flow every 360° shift in the winding coils.

15. The annular linear reduction pump of claim 12 wherein, although the two pole types have opposite directions to those of the traveling magnetic field and of the induced electrical currents, the generated Lorentz forces are in the same direction as the flowing fluid.
sodium coolant; the annular linear induction pump is disposed within a pipe of a test loop of a nuclear reactor

16. A nuclear reactor power system comprising:
a test loop including a riser tube;
an annular linear reduction pump disposed in the riser tube, the annular linear induction pump comprising:
a casing;
an annular duct disposed within the casing, the annular duct having an inner surface and an outer surface; and
an electromagnet comprising:
a center component located within the annular duct and forming the inner surface of the annular duct;
a plurality of stators disposed radially around the annular duct; and
a plurality of coils;
wherein the annular linear induction pump has an outer diameter from about 40 millimeters (mm) to about 100 mm and a length from about 800 mm to about 1500 mm.

17. The nuclear reactor power system of claim 16, wherein the nuclear reaction facility is capable of producing from about 10 MW to about 300 MW.

18. The nuclear reactor power system of claim 16, wherein one or more fluids used to cool fuel rods comprise at least one of a molten lead material, a liquid sodium material, or a liquid sodium-potassium material.

19. A method comprising:
providing a voltage and current to an annular linear reduction pump, the annular linear reduction pump comprising:
a casing;
an annular duct disposed within the casing, the annular duct having an inner surface and an outer surface; and
an electromagnet comprising:
a center component located within the annular duct and forming the inner surface of the annular duct;
a plurality of stators disposed radially around the annular duct; and
a plurality of coils;
wherein the annular linear induction pump has an outer diameter from about 40 millimeters (mm) to about 100 mm and a length from about 800 mm to about 1500 mm.

20. The method of claim 19, wherein the annular linear reduction pump is disposed in a test circuit of a nuclear reactor and cooling fluid flows through the annular linear reduction pump that is comprised of at least one of molten lead, liquid sodium, or a liquid sodium-potassium material;
and wherein flowrates of the cooling fluid is from 1 kg/s to about 20 kg/s at pumping pressures from about 200 kiloPascals (kPa) to about 1500 kPa.
